(19) United States
(12) Patent Application Publication
(10) Pub. No.: US 2024/0314711 A1
(43) Pub. Date: Sep. 19, 2024

(54) TECHNIQUES FOR DETERMINING A COMMON RESOURCE BLOCK GRID WITH FREQUENCY MULTIPLEXED SYNCHRONIZATION SIGNAL BLOCKS

(71) Applicant: QUALCOMM Incorporated, San Diego, CA (US)

(72) Inventors: Hung Dinh Ly, San Diego, CA (US); Yu Zhang, San Diego, CA (US)

(21) Appl. No.: 18/184,509

(22) Filed: Mar. 15, 2023

(51) Int. Cl. H04W 56/00

(52) U.S. Cl. CPC H04W 56/0015; H04W 56/0035

(57) ABSTRACT

Methods, systems, and devices for wireless communication are described. A user equipment (UE) may select a reference synchronization signal block (SSB) from a set of multiple SSBs that are multiplexed in time and frequency. The UE may select the reference SSB from the set of multiple SSBs based on a rule. The UE may receive a control message that indicates a frequency offset between a reference frequency for a common resource block (CRB) grid and a resource block (RB) that overlaps in frequency with the selected reference SSB. The UE may communicate using the CRB grid in accordance with the frequency offset.

### FIELD OF TECHNOLOGY

The following relates to wireless communication, including techniques for determining a common resource block (CRB) grid with frequency multiplexed synchronization signal blocks (SSBs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, fifth generation (5G) systems, and sixth generation (6G) systems, among other subsequent generations, which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities, each supporting wireless communication for communication devices, which may be known as user equipment (UE). Some communication devices may use a common resource block (CRB) grid for wireless communications within the wireless multiple-access communications system.

### SUMMARY

The described techniques relate to improved methods, systems, devices, and apparatuses that support techniques for determining a common resource block (CRB) grid with frequency multiplexed synchronization signal blocks (SSBs). For example, the described techniques may provide a framework for selecting a time and frequency multiplexed SSB for determining one or more aspects of the CRB grid for wireless communications. A user equipment (UE) may select a reference SSB from a set of multiple SSBs that are multiplexed in time and frequency. In some examples, the UE may select the reference SSB from the set of multiple SSBs based on a rule. The UE may receive a control message that indicates a frequency offset between a reference frequency for the CRB grid and a resource block (RB) that overlaps in frequency with the selected reference SSB. The UE may communicate using the CRB grid in accordance with the frequency offset.

A method for wireless communication at a UE is described. The method may include selecting a reference SSB from a set of multiple SSBs that are multiplexed in time and frequency, the selection of the reference SSB is based on a rule, receiving a control message that indicates a frequency offset between a reference frequency for a CRB grid and a RB that overlaps in frequency with the selected reference SSB, and communicating using the CRB grid in accordance with the frequency offset.

An apparatus for wireless communication at a UE is described. The apparatus may include a processor, memory coupled with the processor, and instructions stored in the memory. The instructions may be executable by the processor to cause the apparatus to select a reference SSB from a set of multiple SSBs that are multiplexed in time and frequency, the selection of the reference SSB is based on a rule, receive a control message that indicates a frequency offset between a reference frequency for a CRB grid and a RB that overlaps in frequency with the selected reference SSB, and communicating used the CRB grid in accordance with the frequency offset.

Another apparatus for wireless communication at a UE is described. The apparatus may include means for selecting a reference SSB from a set of multiple SSBs that are multiplexed in time and frequency, the selection of the reference SSB is based on a rule, means for receiving a control message that indicates a frequency offset between a reference frequency for a CRB grid and a RB that overlaps in frequency with the selected reference SSB, and means for communicating using the CRB grid in accordance with the frequency offset.

A non-transitory computer-readable medium storing code for wireless communication at a UE is described. The code may include instructions executable by a processor to select a reference SSB from a set of multiple SSBs that are multiplexed in time and frequency, the selection of the reference SSB is based on a rule, receive a control message that indicates a frequency offset between a reference frequency for a CRB grid and a RB that overlaps in frequency with the selected reference SSB, and communicating used the CRB grid in accordance with the frequency offset.

In some examples of the method, apparatuses, and non-transitory computer-readable medium described herein, selecting the reference SSB may include operations, features, means, or instructions for selecting the reference SSB based on a frequency allocation associated with the reference SSB, where the rule indicates that the selection of the reference SSB may be based on the reference SSB being associated with the frequency allocation.

In some examples of the method, apparatuses, and non-transitory computer-readable medium described herein, the frequency allocation includes a highest frequency allocation or a lowest frequency allocation among a set of multiple frequency allocations associated with the set of multiple SSBs.

In some examples of the method, apparatuses, and non-transitory computer-readable medium described herein, selecting the reference SSB may include operations, features, means, or instructions for selecting the reference SSB based on the reference SSB overlapping in frequency with a reference frequency position, where the rule indicates that the selection of the reference SSB may be based on the reference SSB overlapping in frequency with the reference frequency position.

In some examples of the method, apparatuses, and non-transitory computer-readable medium described herein, the reference frequency position includes a frequency position defined by a synchronization raster.

Some examples of the method, apparatuses, and non-transitory computer-readable medium described herein may further include operations, features, means, or instructions for receiving an indication of the reference SSB, where the rule indicates that the selection of the reference SSB may be based on the indication.

In some examples of the method, apparatuses, and non-transitory computer-readable medium described herein, receiving the indication may include operations, features, means, or instructions for receiving a master information block (MIB) that includes a bit that indicates the reference SSB.

Some examples of the method, apparatuses, and non-transitory computer-readable medium described herein may further include operations, features, means, or instructions for receiving an indication of a subcarrier offset between a first subcarrier included in the RB and a second subcarrier included in the selected reference SSB, where communicating using the CRB grid may be in accordance with the frequency offset and the subcarrier offset.

Some examples of the method, apparatuses, and non-transitory computer-readable medium described herein may further include operations, features, means, or instructions for selecting a second reference SSB from the set of multiple SSBs that may be multiplexed in time and frequency, the selection of the second reference SSB may be based on a second rule that may be different from the rule and receiving an indication of a subcarrier offset between a first subcarrier included in a second RB that overlaps in frequency with the selected second reference SSB and a second subcarrier included in the selected second reference SSB, where communicating using the CRB grid may be in accordance with the frequency offset and the subcarrier offset.

Some examples of the method, apparatuses, and non-transitory computer-readable medium described herein may further include operations, features, means, or instructions for receiving an indication of a RB offset between a first RB of a control resource set included in the CRB grid and the RB, where communicating using the CRB grid may be in accordance with the frequency offset and the RB offset.

Some examples of the method, apparatuses, and non-transitory computer-readable medium described herein may further include operations, features, means, or instructions for selecting a second reference SSB from the set of multiple SSBs that may be multiplexed in time and frequency, the selection of the second reference SSB may be based on a second rule that may be different from the rule and receiving an indication of a RB offset between a first RB of a control resource set included in the CRB grid and a second RB that overlaps in frequency with the selected second reference SSB, where communicating using the CRB grid may be in accordance with the frequency offset and the RB offset.

A method for wireless communication at a network entity is described. The method may include outputting a control message that indicates a frequency offset between a reference frequency for a CRB grid and a RB that overlaps in frequency with a reference SSB of a set of multiple SSBs that are multiplexed in time and frequency, where the reference SSB is based on a rule and communicating using the CRB grid in accordance with the frequency offset.

An apparatus for wireless communication at a network entity is described. The apparatus may include a processor, memory coupled with the processor, and instructions stored in the memory. The instructions may be executable by the processor to cause the apparatus to output a control message that indicates a frequency offset between a reference frequency for a CRB grid and a RB that overlaps in frequency with a reference SSB of a set of multiple SSBs that are multiplexed in time and frequency, where the reference SSB is based on a rule and communicating used the CRB grid in accordance with the frequency offset.

Another apparatus for wireless communication at a network entity is described. The apparatus may include means for outputting a control message that indicates a frequency offset between a reference frequency for a CRB grid and a RB that overlaps in frequency with a reference SSB of a set of multiple SSBs that are multiplexed in time and frequency, where the reference SSB is based on a rule and means for communicating using the CRB grid in accordance with the frequency offset.

A non-transitory computer-readable medium storing code for wireless communication at a network entity is described. The code may include instructions executable by a processor to output a control message that indicates a frequency offset between a reference frequency for a CRB grid and a RB that overlaps in frequency with a reference SSB of a set of multiple SSBs that are multiplexed in time and frequency, where the reference SSB is based on a rule and communicating used the CRB grid in accordance with the frequency offset.

In some examples of the method, apparatuses, and non-transitory computer-readable medium described herein, the rule indicates that the reference SSB may be associated with a frequency allocation.

In some examples of the method, apparatuses, and non-transitory computer-readable medium described herein, the frequency allocation includes a highest frequency allocation or a lowest frequency allocation among a set of multiple frequency allocations associated with the set of multiple SSBs.

In some examples of the method, apparatuses, and non-transitory computer-readable medium described herein, the rule indicates that the reference SSB overlaps in frequency with a reference frequency position.

In some examples of the method, apparatuses, and non-transitory computer-readable medium described herein, the reference frequency position includes a frequency position defined by a synchronization raster.

Some examples of the method, apparatuses, and non-transitory computer-readable medium described herein may further include operations, features, means, or instructions for outputting an indication of the reference SSB in accordance with the rule.

In some examples of the method, apparatuses, and non-transitory computer-readable medium described herein, outputting the indication may include operations, features, means, or instructions for outputting a MIB that includes a bit that indicates the reference SSB.

Some examples of the method, apparatuses, and non-transitory computer-readable medium described herein may further include operations, features, means, or instructions for outputting an indication of a subcarrier offset between a first subcarrier included in the RB and a second subcarrier included in the reference SSB, where communicating using the CRB grid may be in accordance with the frequency offset and the subcarrier offset.

Some examples of the method, apparatuses, and non-transitory computer-readable medium described herein may further include operations, features, means, or instructions for outputting an indication of a subcarrier offset between a first subcarrier included in a second RB that overlaps in frequency with a second reference SSB of the set of multiple SSBs and a second subcarrier included in the second reference SSB, where the second reference SSB may be based on a second rule that may be different from the rule, and where communicating using the CRB grid may be in accordance with the frequency offset and the subcarrier offset.

Some examples of the method, apparatuses, and non-transitory computer-readable medium described herein may further include operations, features, means, or instructions for outputting an indication of a RB offset between a first RB of a control resource set included in the CRB grid and the RB, where communicating using the CRB grid may be in accordance with the frequency offset and the RB offset.

Some examples of the method, apparatuses, and non-transitory computer-readable medium described herein may further include operations, features, means, or instructions for outputting an indication of a RB offset between a first RB of a control resource set included in the CRB grid and a second RB that overlaps in frequency with a second reference SSB of the set of multiple SSBs, where the second reference SSB may be based on a second rule that may be different from the rule, and where communicating using the CRB grid may be in accordance with the frequency offset and the RB offset.

### BRIEF DESCRIPTION OF THE DRAWINGS

FIGS. 1 and 2 each illustrate an example of a wireless communications system that supports techniques for determining a common resource block (CRB) grid with frequency multiplexed synchronization signal blocks (SSBs) in accordance with one or more aspects of the present disclosure.

FIGS. 3A and 3B each illustrate an example of a CRB grid diagram that supports techniques for determining a CRB grid with frequency multiplexed SSBs in accordance with one or more aspects of the present disclosure.

FIGS. 4A and 4B each illustrate an example of a resource block (RB) diagram that supports techniques for determining a CRB grid with frequency multiplexed SSBs in accordance with one or more aspects of the present disclosure.

FIG. 5 illustrates an example of a process flow that supports techniques for determining a CRB grid with frequency multiplexed SSBs in accordance with one or more aspects of the present disclosure.

FIGS. 6 and 7 illustrate block diagrams of devices that support techniques for determining a CRB grid with frequency multiplexed SSBs in accordance with one or more aspects of the present disclosure.

FIG. 8 illustrates a block diagram of a communications manager that supports techniques for determining a CRB grid with frequency multiplexed SSBs in accordance with one or more aspects of the present disclosure.

FIG. 9 illustrates a diagram of a system including a device that supports techniques for determining a CRB grid with frequency multiplexed SSBs in accordance with one or more aspects of the present disclosure.

FIGS. 10 and 11 illustrate block diagrams of devices that support techniques for determining a CRB grid with frequency multiplexed SSBs in accordance with one or more aspects of the present disclosure.

FIG. 12 illustrates a block diagram of a communications manager that supports techniques for determining a CRB grid with frequency multiplexed SSBs in accordance with one or more aspects of the present disclosure.

FIG. 13 illustrates a diagram of a system including a device that supports techniques for determining a CRB grid with frequency multiplexed SSBs in accordance with one or more aspects of the present disclosure.

FIGS. 14 through 17 illustrate flowcharts showing methods that support techniques for determining a CRB grid with frequency multiplexed SSBs in accordance with one or more aspects of the present disclosure.

### DETAILED DESCRIPTION

Some wireless communications systems, such as sixth generation (6G) systems, may support one or more cellular radio access technologies (RATs). In some examples, the cellular RATs may deploy one or more radio frequency bands that may include relatively high radio frequencies, such as radio frequencies between about 7 gigahertz (GHz) to about 24 GHz (or some other suitable range of radio frequencies). In some examples, however, signals transmitted using relatively high radio frequencies may experience increased path loss, and therefore reduced coverage, relative to signals transmitted using relatively low radio frequencies. In some examples, to increase coverage of a transmission using relatively high radio frequencies, a communication device (e.g., a user equipment (UE), a network entity) may increase a quantity of signals being transmitted. For example, the network entity may use one or more multiplexing techniques to increase the quantity of signals being transmitted from the network entity to the UE using relatively high radio frequencies. In some examples, the network entity may use time division multiplexing (TDM) to transmit the increased quantity of signals. In some examples, however, using TDM to transmit an increased quantity of signals may lead to an increased transmission time and increased power consumption at the network entity and the UE. In some other examples, the network entity may use hybrid beamforming to multiplex signals in frequency and in time. For example, hybrid beamforming may incorporate analog beamforming to multiplex multiple signals in time and digital beamforming to multiplex signals in frequency. In some examples, using hybrid beamforming to multiplex multiple signals in time and in frequency may lead to a reduced transmission time and reduced power consumption.

In some examples, however, multiplexing synchronization signal blocks (SSBs) in frequency and in time may increase a complexity associated with SSB acquisition at the UE. For example, the UE may be configured with a frequency offset for determining a frequency location of a common resource block (CRB) grid used for wireless communications with the network entity. In such an example, the frequency offset may correspond to an offset (e.g., a difference) between a reference frequency for the CRB grid and a resource block (RB) that overlaps in frequency with an SSB transmitted from the network entity. In other words, the UE may use a frequency allocation of an SSB transmitted from the network entity to determine the frequency position of the CRB grid.

In some examples, such as examples in which the network entity may use TDM to multiplex multiple SSBs in time, the multiple SSBs may have a same frequency allocation. Accordingly, the UE may determine a same frequency location for the CRB grid irrespective of which SSB the UE may select for the determination. In some other examples, such as examples in which the network entity may use hybrid beamforming to multiplex multiple SSBs in time and in frequency, the multiple SSBs may have multiple (e.g., different) frequency allocations. In such examples, the UE may lack a mechanism, much less an effective mechanism, for determining an SSB (e.g., which SSB) to use for determining the frequency position of the CRB grid.

Various aspects of the present disclosure generally relate to techniques for determining a CRB grid with frequency multiplexed SSBs. For example, the network entity may transmit a set of SSBs to the UE that may be multiplexed in time and frequency. The UE may select a reference SSB from the set of SSBs based on a rule. In some examples, the rule may configure the UE to select the reference SSB based on the reference SSB being associated with a particular frequency allocation, such as a highest frequency allocation or a lowest frequency allocation among frequency allocations associated with the set of SSBs. In some other examples, the rule may configure the UE to select the reference SSB based on the reference SSB overlapping in frequency with a particular frequency position, such as a frequency position that may be based on the synchronization raster. In other examples, the rule may configure the UE to select the reference SSB based on the reference SSB being indicated to the UE, for example, via a bit included in a master information block (MIB) of the reference SSB.

Aspects of the subject matter described herein may be implemented to realize one or more of the following potential advantages. For example, techniques for determining a CRB grid with frequency multiplexed SSBs, as described herein, may be employed by the described communication devices to provide benefits and enhancements to the operation of the communication devices, including enable the UE to select a reference SSB from a set of frequency multiplexed SSBs. Further, such techniques may support reduced power consumption, among other possible benefits. Aspects of the disclosure are initially described in the context of wireless communications systems. Aspects of the disclosure are also described in the context of CRB grid diagrams, RB diagrams, and a process flow. Aspects of the disclosure are further illustrated by and described with reference to apparatus diagrams, system diagrams, and flowcharts that relate to techniques for determining a CRB grid with frequency multiplexed SSBs.

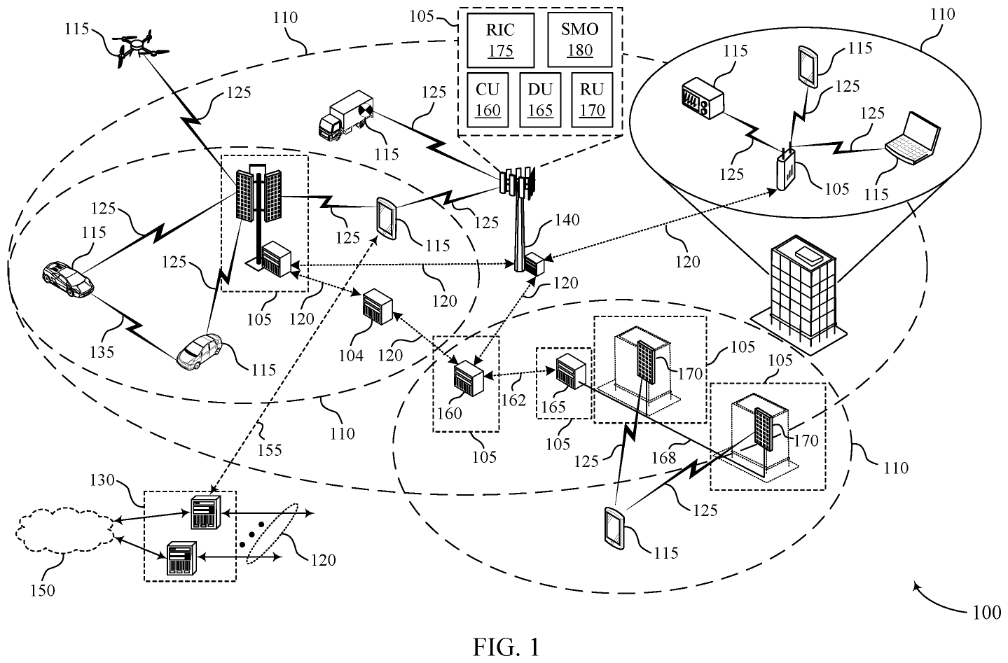

FIG. 1 illustrates an example of a wireless communications system 100 that supports techniques for determining a CRB grid with frequency multiplexed SSBs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more RATs.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB or 6G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, radio frequency functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for determining a CRB grid with frequency multiplexed SSBs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the radio frequency spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element (RE) may refer to resources of one symbol period (e.g., a duration of one modulation symbol) and one subcarrier, in which case the symbol period and subcarrier spacing may be inversely related. The quantity of bits carried by each RE may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an radio frequency spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 GHz. Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed radio frequency spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support radio frequency beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, a network entity 105 may multiplex SSBs in frequency and in time, for example, to increase coverage of SSB transmissions using relatively high radio frequencies. In some examples, however, multiplexing SSBs in frequency may increase a complexity associated with SSB acquisition at a UE 115. For example, the UE 115 may lack a mechanism, much less an effective mechanism, for determining an SSB (e.g., which SSB) of the frequency multiplexed SSBs to use for determining a frequency position of a CRB grid.

In some other examples, the UE 115 may support a framework for selecting a reference SSB from a set of time and frequency multiplexed SSBs. For example, the UE 115 may select the reference SSB from the set of SSBs based on a rule. The rule may configure the UE 115 to select the reference SSB based on the reference SSB being associated with a particular frequency allocation or a particular frequency position. In some other examples, the rule may configure the UE 115 to select the reference SSB based on an indication from the network entity 105. The UE may receive a control message that indicates a frequency offset between a reference frequency for the CRB grid and an RB that overlaps in frequency with the selected reference SSB. In such examples, the UE 115 may communicate with the network entity 105 using the CRB grid in accordance with the frequency offset.

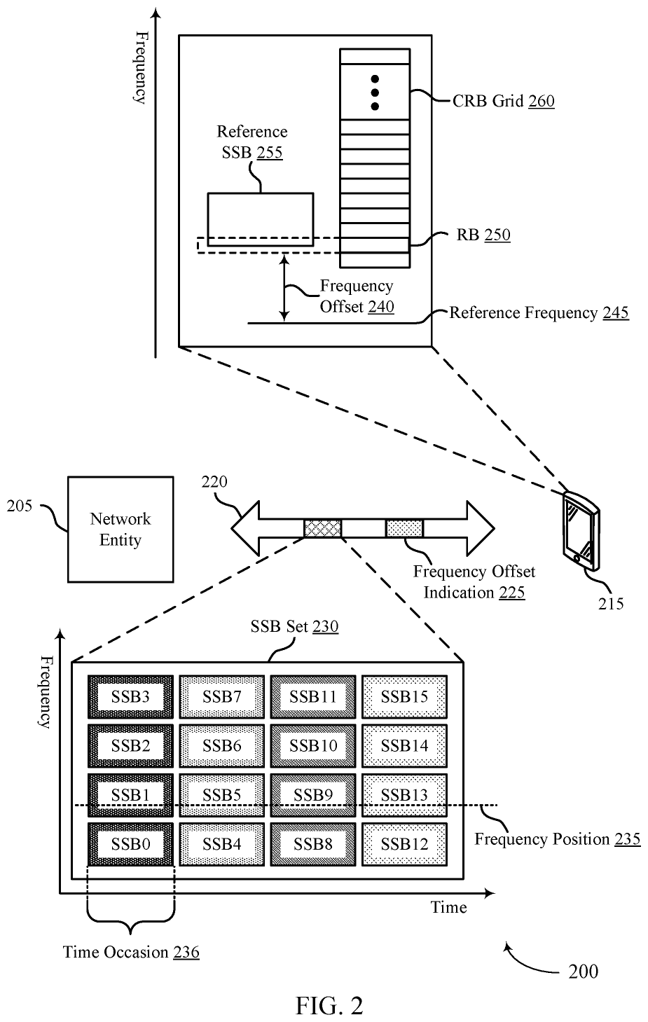

FIG. 2 illustrates an example of a wireless communications system 200 that supports techniques for determining a CRB grid with frequency multiplexed SSBs in accordance with one or more aspects of the present disclosure. The wireless communications system 200 may implement aspects of the wireless communications system 100. For example, the wireless communications system 200 may include a UE 215 and a network entity 205, which may be examples of the corresponding devices illustrated by and described with reference to FIG. 1. The network entity 205 and the UE 215 may communicate via a communication link 220, which may be an example of a communication link 125 (e.g., a Uu interface) illustrated by and described with reference to FIG. 1. For example, the communication link 220 may be an example of an uplink or a downlink (or both).

The wireless communications system 200 (e.g., a 6G system) may support one or more cellular RATs. In some examples, a cellular RAT may support one or more radio frequency spectrum bands (e.g., licensed radio frequency spectrum bands, unlicensed radio frequency spectrum bands) across multiple ranges of radio frequencies. For example, the cellular RAT may deploy relatively low radio frequency ranges, such as frequency range 1 (FR1). FR1 may include radio frequency bands below 6 GHz. Additionally, or alternatively, the cellular RAT may deploy relatively high radio frequency ranges, such as a frequency range 2 (FR2) and frequency range 3 (FR3). FR2 may span about 24.25-52.6 GHz (or some other suitable range of radio frequencies) and FR3 may span about 7-24 GHz (or some other suitable range of radio frequencies). In some examples, however, signals transmitted using relatively high radio frequencies, such as 13 GHz, may experience more path loss, and therefore reduced coverage, compared to signals transmitted using relatively low radio frequencies, such as 3.5 GHz. As an illustrative example, signals transmitted using FR3 (e.g., using 13 GHz) may experience about 11.5 dB higher pathloss compared to signals transmitted using FRI (e.g., using 3.5 GHZ). A relatively high loss model may be used to model scenarios in which signals may be transmitted in an environment that includes infrared reflective glass or concrete. In accordance with the relatively high loss model, signals transmitted using FR3 (e.g., using 13 GHZ) may, in some examples, experience about 6.6 dB more penetration loss (e.g., outdoor-to-indoor penetration loss associated with infrared reflective glass or concrete) compared to signals transmitted using FRI (e.g., using 3.5 GHZ). In accordance with a relatively low loss model, signals transmitted using FR3 (e.g., using 13 GHZ) may, in some examples, experience about 2.1 dB more penetration loss compared to signals transmitted using FRI (e.g., using 3.5 GHZ). In some examples, signals transmitted using relatively high radio frequency ranges (e.g., radio frequencies that may be included in FR3) may experience up to about 18 dB more channel loss compared to signaling transmitted using relatively low radio frequency ranges (e.g., radio frequencies that may be included in FR1). In other words, higher frequency ranges may provide reduced coverage relative to lower frequency ranges. As such, deployment of relatively high radio frequency ranges (e.g., FR3) with relatively low radio frequency ranges (e.g., FR1) may be relatively difficult.

In some examples, to improve deployment of relatively high radio frequency ranges (e.g., FR3) with relatively low radio frequency ranges (e.g., FR1), the wireless communications system 200 may support giga-MIMO. For example, the wireless communications system 200 may support a giga-MIMO design, which may lead to increased gains and reduced propagation loss for signals transmitted using relatively high radio frequency ranges. That is, the giga-MIMO design may enable (e.g., allow for, provide for) realization (e.g., full realization) of potential gains and reduced propagation loss for signals transmitted using relatively high radio frequency ranges. In other words, the giga-MIMO design may compensate for relatively challenging propagation conditions associated with relatively high radio frequency ranges (e.g., FR3).

The network entity 205 may support giga-MIMO communications with the UE 215. In some examples of giga-MIMO communications at the network entity 205 (e.g., a giga-MIMO gNB), the network entity 205 may include an increased quantity of antennas (e.g., gNB antennas). For example, increasing a frequency of a signal may decrease a wavelength of the signal. That is, signals transmitted using relatively high radio frequencies (e.g., using FR3) may have smaller wavelengths relative to signals transmitted using relatively low radio frequencies (e.g., using FR1). Accordingly, the network entity 205 may use relatively small antennas (e.g., antenna elements) to transmit signals using relatively high radio frequencies. As such, an aperture of an antenna panel used for relatively high radio frequencies may include (e.g., accommodate for, support) more antenna elements than another aperture that may be of a same size as the aperture but used for relatively low radio frequencies. Accordingly, a giga-MIMO antenna panel used at the network entity 205 for relatively high radio frequency ranges (e.g., FR3) may accommodate an increased quantity of antenna elements relative to other antenna panels that may be used for relatively low radio frequency ranges (e.g., FR1), while maintaining a same aperture size (e.g., area). For example, a giga-MIMO antenna panel that may be used at the network entity 205 for relatively high radio frequency ranges (e.g., for FR3) may support about 4,000 (4K) antenna elements (or some other suitable quantity of antenna elements) and about 256 RUs (or some other suitable quantity of RUs).

In some examples, a quantity of antenna elements included in a giga-MIMO antenna panel may be based on a multiplexing mode used with the giga-MIMO antenna panel. For example, in a TDD mode, a giga-MIMO antenna panel may include about 4K antenna elements (e.g., two arrays in which each array may include 64 antenna elements in a first direction and 32 antenna elements in a second direction). In such an example, the giga-MIMO antenna panel may provide a quantity of degrees of freedom (DoF), such as 265 digital DoF per RU (e.g., two arrays in which each array may include 4 transmission or reception DoF and 32 azimuthal DoF). In some examples, the network entity 205 may support an FDD mode in which two panels (e.g., two giga-MIMO antenna panels) may be used for simultaneous transmission and reception. In such examples, a giga-MIMO antenna panel (e.g., each of the two giga-MIMO antenna panels) used at the network entity 205 for FDD may include one or more subpanels. In some examples, a subpanel (e.g., each subpanel) may include about 2,000 (2K) antenna elements (e.g., two arrays in which each array may include 32 antenna elements in a first direction and 32 antenna elements in a second direction). The 2K antenna elements may be mapped to 128 transmission RUs (e.g., each RU may include two arrays in which each array may include 2 transmission or reception DoF and 32 azimuthal DoF).

In some examples, an increased quantity of antennas (e.g., antenna elements) may enable the network entity 205 to achieve increased gains, while maintaining a similar antenna aperture as may be used for other types of wireless communications, such as other types of MIMO communications (e.g., massive MIMO). For example, the increased quantity of antennas may enable the network entity 205 to increase a power (e.g., strength, intensity) of signals output at the network entity 205 via the antennas (e.g., and using relatively high radio frequencies), while maintaining a suitably-sized antenna aperture. In some examples, by increasing a quantity of antennas at the network entity 205 by about 16 times, the network entity 205 may increase transmit power at the network entity 205 by about 12 dB (or some other suitable quantity of dBs). That is, by increasing the quantity of antennas at the network entity 205 by about 16 times, the network entity 205 may achieve about a 12 dB gain (or some other suitable gain). Additionally, increasing a digital beamforming capacity at the network entity 205 may lead to increased spatial multiplexing at the network entity 205. In some examples, the UE 215 may include an increased quantity of antennas (e.g., downlink antennas or uplink antennas), which may enable the UE 215 to increase a transmit power at the UE 215 (e.g., for transmission of uplink signals). For example, by increasing a quantity of antennas at the UE 215 by about two times, the UE 215 may increase a transmit power at the UE 215 by about 3 dB (or some other suitable quantity of dBs). That is, by increasing the quantity of antennas at the UE 215 by about two times, the UE 215 may achieve about a 3 dB gain (or some other suitable gain). Additionally, using a relatively higher system bandwidth may lead to one or more gains at the UE 215 (or the network entity 205). For example, by increasing a system bandwidth used at the UE 215 for uplink communications from about 100 MHz to about 500 MHz the UE 215 may increase a transmit power at the UE 215 by about 7 dB (or some other suitable quantity of dBs). That is, by increasing a system bandwidth used at the UE 215 for uplink communications from about 100 MHz to about 500 MHz, the UE 215 may achieve about a 7 dB gain (or some other suitable gain).

In some examples, a type of beamforming used for a transmission may be based on a frequency range used for the transmission. For example, the network entity 205 may use digital beamforming (e.g., beamforming in digital domain) for transmissions using one or more frequency ranges (e.g., lower frequency ranges, such as FR1) and analog beamforming (e.g., beamforming in analog domain) for one or more other transmissions using one or more other frequency ranges (e.g., higher frequency ranges, such as FR2). For some frequency ranges, such as frequency ranges between FR1 and FR2, such as for FR3, the network entity 205 may use (e.g., support) hybrid beamforming. For example, the network entity 205 may include a giga-MIMO antenna panel that may enable the network entity 205 to support one or more hybrid beamforming technologies. Hybrid beamforming technologies may include (e.g., incorporate) digital beamforming and analog beamforming. For example, hybrid beamforming may provide 16:1 analog combining over two stages (e.g., 4:1 fixed combining for digital beamforming and 4:1 programmable phasors for analog beamforming), dynamic adaptation of combiners (e.g., to improve array gain), and singular value decomposition signal-to-leakage ratio (SVD-SLR) digital beamforming (e.g., to improve spatial multiplexing). In other words, hybrid beamforming may combine analog beamforming (e.g., use of phase-shifters to transmit a same signal from multiple antennas but with different phases) and digital beamforming (e.g., generating a different signal for each antenna element in a digital baseband).

In some examples, a type of multiplexing used for a transmission may be based on a frequency range used for the transmission. For example, the network entity 205 may use one or more multiplexing techniques to transmit multiple signals, such a broadcast signals. The broadcast signals may include synchronization signals (SSs) and physical broadcast channel (PBCH) signals. In some examples, the SSs and PBCH signals may be transmitted together, for example using an SSB. For example, an SS and PBCH signal may be packed as a single block (e.g., an SSB) that may be transmitted together. That is, in some examples, an SSB may refer to an SS/PBCH block. In some examples, an SS may include a primary synchronization signal (PSS) or a secondary synchronization signal (SSS), or both. Additionally, in some examples, a PBCH signal may include reference signals (e.g., demodulation reference signals (DMRS)), or data, or both. For example, a PBCH signal may include a master information block (MIB). The MIB may include one or more types of system information. In some examples, such as for relatively low radio frequency ranges (e.g., FR1), the network entity 205 may use or more subcarrier spacings (SCSs), such as a 15 kHz SCS or a 30 kHz SCS. In such examples, the network entity 205 may use TDM to transmit multiple signals, such as SSBs (e.g., with or without remaining system information (RMSI)). For example, the network entity 205 may transmit about 4 SSBs for a carrier frequency that may be at or below a threshold frequency (e.g., 3 GHZ) and about 8 SSBs for a carrier frequency that may be above the threshold frequency. In some other examples, such as for relatively high radio frequency ranges (e.g., FR2), the network entity 205 may use one or more other SCSs, such as a 120 kHz SCS or a 240 kHz SCS. In such examples, the network entity 205 may use TDM or FDM to transmit multiple (e.g., about 64) SSBs. For example, the network entity 205 may use TDM to transmit multiple SSBs without RMSI and TDM or FDM to transmit multiple SSBs without RMSI.

In some examples, the network entity 205 may transmit an increased quantity of signals to increase coverage of a transmission. For example, relatively high radio frequency ranges may be associated with reduced coverage. Accordingly, to increase coverage for signals transmitted using relatively high radio frequency ranges, the network entity 205 may transmit an increased quantity (e.g., more) of signals. In other words, the network entity 205 may increase coverage of a transmission by increasing a quantity of signals being transmitted, such as via multiplexing. In some examples, such as for FR3 (e.g., with a carrier frequency between about 7 GHz and 16 GHZ), the network entity 205 may use a 30 kHz SCS (or some other suitable SCS) for transmission of some signals (e.g., SSBs). In such an example, to compensate for a relatively high path loss in FR3, the network entity 205 may transmit a relatively high quantity of SSBs (e.g., about 16). In some examples, however, a TDM design for SSBs may lead to increased (e.g., longer) time occupancy. That is, using TDM to multiplex an increased quantity of signals may lead to an increased transmission time and, accordingly, increased power consumption. For example, an increased transmission time at the network entity 205 may lead to an increased reception time at the UE 215, which may lead to increased power consumption at the UE 215. As an illustrative example, the network entity 205 may transmit two SSBs per slot. In such an example, transmitting 16 SSBs via TDM may use (e.g., necessitate the use of) 8 slots (e.g., over about 4 ms using 30 kHz SCS). In other words, multiplexing multiple signals, such as SSBs, in the time domain (e.g., via TDM) may lead to increased reception times or measurement times (or both) at the UE 215, which may lead to increased power consumption the UE 215.

In some other examples, the network entity 205 may use (e.g., leverage) hybrid beamforming to multiplex signals (e.g., SSBs) in frequency and in time. For example, hybrid beamforming may incorporate analog beamforming to multiplex multiple signals in time and digital beamforming to multiplex signals in frequency. That is, the network entity 205 may use hybrid beamforming to multiplex signals in time via analog beamforming and in frequency via digital beamforming, which may lead to increased power savings at the UE 215. For example, using hybrid beamforming to multiplex multiple signals in time and in frequency may reduce a reception time or a measurement time (or both) at the UE 215, which may lead to reduced power consumption at the UE 215. Additionally, in some examples, use of hybrid beamforming may lead to increased (e.g., higher) network power savings, for example, by reducing a transmission time (e.g., in empty load scenarios) at the network entity 205. That is, hybrid beamforming may enable the network entity 205 to multiplex multiple SSBs in frequency and in time. In some examples, however, multiplexing SSBs in frequency and in time (e.g., using both TDM and FDM to transmit SSBs) may lead to relatively higher UE complexity for SSB acquisition.

For example, the network entity 205 may transmit one or more SSBs to the UE 215 as part of a cell search procedure. In such an example, the UE 215 may use one or more of the SSBs transmitted as part of the cell search procedure (or another procedure) to obtain time and frequency synchronization information associated with a cell that may be served by the network entity 205. For example, the UE 215 may use one or more SSBs transmitted from the network entity 205 to obtain (e.g., determine, identify) information that the UE 215 may use to synchronize (e.g., in time and in frequency) with the network entity 205, such as during initial access. To obtain the synchronization information the UE 215 may tune to a particular frequency to detect (or attempt to detect) an SSB, which may include synchronization signals (e.g., PSS and SSS signals). The UE may use one or more detected PSS and SSS signals to obtain the frequency and time synchronization information. That is, in response to detecting (e.g., and decoding) an SSB, the UE 215 may obtain frequency and time synchronization information (e.g., and other information, such as a PCI) for the cell that may be served by the network entity 205 (e.g., to establish a connection with the network entity 205).

The UE 215 may use a CRB grid 260 for wireless communications with the network entity 205. In some examples, the UE 215 may use frequency information of one or more SSB to obtain information associated with the CRB grid 260. For example, the UE 215 may use (e.g., may be configured to use) a particular SSB to identify a location in frequency (e.g., a frequency location, a frequency position) of the CRB grid 260. In some examples, the UE 215 may be configured to use a cell-defining SSB to identify the frequency location of the CRB grid 260. That is, the UE 215 may use cell-defining SSBs to determine a frequency location of the CRB grid 260 for communications with the network entity 205. A cell-defining SSB may refer to an SSB that the UE 215 may use for system acquisition of the cell. For example, cell-defining SSBs may be examples of SSBs that include (e.g., carry) a system information block (SIB). In some examples, to identify a frequency that the UE 215 may use (e.g., tune to) to detect a cell-defining SSB transmitted from the network entity 205, the UE 215 may scan a frequency band associated with the cell procedure. In some examples, the UE 215 may scan the frequency band in accordance with a synchronization raster that may define a frequency distance between two consecutive frequency locations. The synchronization raster may be associated with cell-defining SSBs and, in some examples, based on the frequency band that the UE 215 may be performing the cell search procedure on. For example, the synchronization raster may indicate a frequency location of one or more cell-defining SSBs that the UE 215 may use for system acquisition for a cell (e.g., a primary cell (PCell) served by the network entity 205), which the UE 215 may access via the cell search procedure.

As illustrated in the example of FIG. 2, a reference frequency 245 (e.g., point A) may be a common reference point for the CRB grid 260. For example, the UE 215 may use the reference frequency 245 to determine the CRB grid 260 (e.g., the frequency location of the CRB grid 260). In some examples, the UE 215 may determine the reference frequency 245 (e.g., a frequency location of the reference frequency 245) based on signaling from the network, such as via an absoluteFrequencyPointA information element (IE). For example, the absoluteFrequencyPointA IE may indicate the frequency location of the reference frequency 245 expressed as an absolute radio frequency channel number (ARFCN).

In some other examples, the UE 215 may obtain (e.g., determine, identify) the frequency location of the reference frequency 245 based on a frequency offset 240. The frequency offset 240 may be indicated to (e.g., or otherwise configured at) the UE 215. For example, the network entity 205 may transmit control signaling to indicate the frequency offset 240 to the UE 215. In some examples, the control signaling may include an IE, such as a offsetToPointA IE, that indicates the frequency offset 240. In some examples, the frequency offset 240 may be defined relative to a frequency location of an SSB, such as a cell-defining SSB. That is, the UE 215 may use a cell-defining SSB and the frequency offset 240 associated with the reference frequency 245 to determine the frequency location of the reference frequency 245 (e.g., and the frequency location of the CRB grid 260). For example, the frequency offset 240 may correspond to an offset (e.g., difference) between an RB 250 included in the CRB grid 260 and the frequency offset 240. In such an example, the UE 215 may identify the RB 250 based on the RB 250 overlapping with a reference SSB 255, which may be an example of a cell-defining SSB. Additionally, in some examples, the UE 215 may use the cell-defining SSBs to determine one or more frequency locations associated with one or more other offsets, such as an RB offset (or an RE offset) and a subcarrier offset.

As illustrated in the example of FIG. 2, the network entity 205 may transmit an SSB set 230 to the UE 215, which may include a quantity (N) of SSBs. In some examples, the SSBs included in the SSB set 230 may be examples of cell-defining SSBs. That is, the quantity of SSBs included in the SSB set 230 may be associated with the synchronization raster. For example, the network entity 205 may transmit the SSB set 230 to the UE 215, which may include N (e.g., 16) SSBs. The SSBs included in the SSB set 230 may be indexed from 0 to 15. In some examples, the network entity 205 may use hybrid beamforming to transmit the SSB set 230 to the UE 215, such that the SSB set 230 may be multiplexed in time (e.g., via analog beamforming) and in frequency (e.g., via digital beamforming). That is, the network entity 205 may use analog beamforming to achieve TDM for the SSB set 230 and digital beamforming to achieve FDM for the SSB set 230. Accordingly, the network entity 205 may transmit the SSB set 230 to the UE 215 over multiple time occasions and using multiple (e.g., different) radio frequencies (e.g., frequency allocations). In such examples, a subset (M) of the SSBs included in the SSB set 230 may be simultaneously transmitted (e.g., via FDM using the digital beamforming) during a time occasion (e.g., each time occasion used for TDM). For example, during a time occasion 236, the network entity 205 may use FDM (e.g., as part of the hybrid beamforming) to simultaneously transmit a subset of the SSBs included in the SSB set 230 (e.g., 4 SSBs, which may be indexed from 0 to 3) to the UE 215. As such, the subset of SSBs simultaneously transmitted during the time occasion 236 may be multiplexed in frequency and be associated with multiple (e.g., different) frequency allocations. In other words, SSB0, SSB1, SSB2, and SSB3, which may be simultaneously transmitted during the time occasion 236, may each be associated with a respective frequency. In the example of FIG. 2, each SSB transmitted during the time occasion 236 (e.g., SSB0, SSB1, SSB2, and SSB3) may be associated with (e.g., have) a different frequency allocation.

As illustrated in the example of FIG. 2, the UE 215 may determine (e.g., identify) the reference frequency 245 based on a frequency location of the reference SSB 255. The reference SSB 255 may be a cell-defining SSB. For example, the UE 215 may be configured to determine the reference frequency 245 in accordance with the frequency offset 240. The frequency offset 240 may be indicated to the UE 215 via an IE, such as the offsetToPointA IE. The frequency offset 240 may represent an offset between the reference frequency 245 (e.g., point A) and a lowest subcarrier among subcarriers included in the RB 250. The RB 250 may be a lowest RB among RBs included in the CRB grid 260, which may be overlapping with the reference SSB 255. The lowest subcarrier may correspond to a subcarrier associated with a lowest frequency allocation among frequency allocations associated with subcarriers included in the RB 250. The lowest RB (e.g., the RB 250) may correspond to an RB associated with a lowest frequency allocation among frequency allocations associated with RBs included in the CRB grid 260 that may be overlapping with the reference SSB 255. That is, the RB 250 may correspond to an RB associated with a lowest frequency allocation among frequency allocations associated with RBs that are both included in the CRB grid 260 and overlapping with the reference SSB 255.

In some examples, the network entity 205 may use TDM (e.g., and refrain from using FDM) to transmit multiple cell-defining SSBs to the UE 215. In such examples, the cell-defining SSBs (e.g., all of the cell-defining SSBs) may have a same frequency allocation. That is, for examples in which the network entity 205 may use TDM to transmit cell-defining SSBs (e.g., having an associated SIB1 PDSCH) to the UE 215, the frequency information (e.g., point A, the RB offset or RE offset) used to determine the CRB grid 260 may be based on cell-defining SSBs that have a same (e.g., identical) frequency allocation. In other words, if the network entity 205 uses TDM to transmit cell-defining SSBs to the UE 215, the frequency information used to determine the frequency location of the CRB grid 260 may be based on cell-defining SSBs that have a same frequency allocation. For example, in accordance with the TDM design for SSBs, the network entity 205 may transmit multiple cell-defining SSBs to the UE 215 over multiple time occasions and the multiple cell-defining SSBs may have a same frequency allocation. Accordingly, the UE 215 may select a cell defining SSB (e.g., any one of the multiple cell-defining SSBs) transmitted from the network entity 205 to use as the reference SSB 255 (e.g., for determining the frequency location of the CRB grid 260). In other words, if a set of cell-defining SSBs have a same frequency allocation (e.g., due to being multiplexed in time), the UE 215 may determine a same frequency location for the reference frequency 245 (e.g., in accordance with the frequency offset 240) irrespective of which SSB the UE 215 may select from the set for the determination.

In some other examples, however, the network entity 205 may multiplex a set of SSBs, such as the SSB set 230, in time and in frequency. For example, the network entity 205 may use hybrid beamforming (e.g., both TDM and FDM) to transmit the SSB set 230 to the UE 215. That is, as illustrated in FIG. 2, the network entity 205 may transmit the SSB set 230 using hybrid beamforming, such that the SSBs included in the SSB set 230 may be multiplexed in time and in frequency. In such examples, the network entity 205 may transmit multiple SSBs during the time occasion 236 and each SSB may have a respective (e.g., different) frequency allocation. For example, the network entity 205 may transmit SSB0, SSB1, SSB2, and SSB3 during the time occasion 236 and each SSB of the subset may have a different frequency allocation. As such, a frequency location determined at the UE 215 for the reference frequency 245 (e.g., in accordance with the frequency offset 240) may be based on an SSB (e.g., which SSB) the UE 215 may select from the SSB set 230 for the determination. In some examples, however, the UE 215 may lack a mechanism for determining an SSB (e.g., which SSB of the SSB set 230) to use for the determination of the CRB grid 260. In other words, if the cell-defining SSBs are multiplexed in frequency, the UE 215 may lack a mechanism for selecting an SSB to use for determining the lowest RB of the CRB grid 260.

In some examples, such as examples in which cell-defining SSBs may have different frequency allocations, the UE 215 may use one or more enhancement for determination of the CRB grid 260. Techniques for determining a CRB grid with frequency multiplexed SSBs, as described herein, may provide one or more enhancement for determination of the CRB grid 260. For example, such techniques may provide a framework for the UE 215 to select a time and frequency multiplexed SSB for determining one or more aspects of the CRB grid 260 for wireless communications with the network entity 205. That is, techniques for determining a CRB grid with frequency multiplexed SSBs, as described herein, may enable determination of the CRB grid 260 (e.g., a frequency location of the CRB grid 260) for examples in which FDM for SSBs may be deployed.

For example, the SSB set 230 may include multiple SSBs that may be multiplexed in time and frequency. The UE 215 may select the reference SSB 255 from the SSB set 230 based on a rule. In some examples, the rule may configure the UE 215 to select the reference SSB 255 based on the reference SSB 255 being associated with a frequency allocation, such as a highest frequency allocation or a lowest frequency allocation among frequency allocations associated with SSBs included in the SSB set 230. In other words, the rule may configure the UE 215 to select SSB3, SSB7, SSB11, or SSB15 to use as the reference frequency 245 based on SSB3, SSB7, SSB11, and SSB15 being associated with the highest frequency allocation among frequency allocations associated with the SSB set 230. Alternatively, the rule may configure the UE 215 to select SSB0, SSB4, SSB8, or SSB12 to use as the reference frequency 245 based on SSB0, SSB4, SSB8, and SSB12 being associated with a lowest frequency allocation among the frequency allocations associated with the SSBs included in the SSB set 230. In some examples, the UE 215 may identify a respective frequency location of an SSB (e.g., each SSB) included in the SSB set 230 based on receiving an SSB (e.g., any SSB) included in the SSB set 230.

In some other examples, the rule may configure the UE 215 to select the reference SSB 255 based on the reference SSB 255 overlapping in frequency with the frequency position 235. For example, the rule may configure the UE 215 to select SSB1, SSB5, SSB9, or SSB13 to use as the reference frequency 245 based on SSB5, SSB9, and SSB13 overlapping in frequency with the frequency position 235. In other examples, the rule may configure the UE 215 to select the reference SSB 255 based on an indication from the network entity 205. For example, the network entity 205 may transmit an indication of an SSB to the UE 215 and, in accordance with the rule, the UE 215 to select the indicated SSB as the reference SSB 255. In some examples, the network entity 205 may transmit the indication of the SSB to the UE 215 via a bit in an MIB (e.g., a MIB in the SSB). For example, the rule may configure the UE 215 to select an SSB to use as the reference SSB 255 based on an indication included in an MIB of the SSB.

In some examples, the UE 215 may receive a control message that may include a frequency offset indication 225. The frequency offset indication 225 may indicate, to the UE 215, the frequency offset 240 between the reference frequency 245 for the CRB grid 260 and the RB 250 that overlaps in frequency with the reference SSB 255 (e.g., the selected reference SSB). The UE 215 may communicate with the network entity 205 using the CRB grid 260 in accordance with the frequency offset 240. In some examples, selecting the reference SSB 255 in accordance with the rule, may lead to reduce power consumption at the UE 215, among other possible benefits.

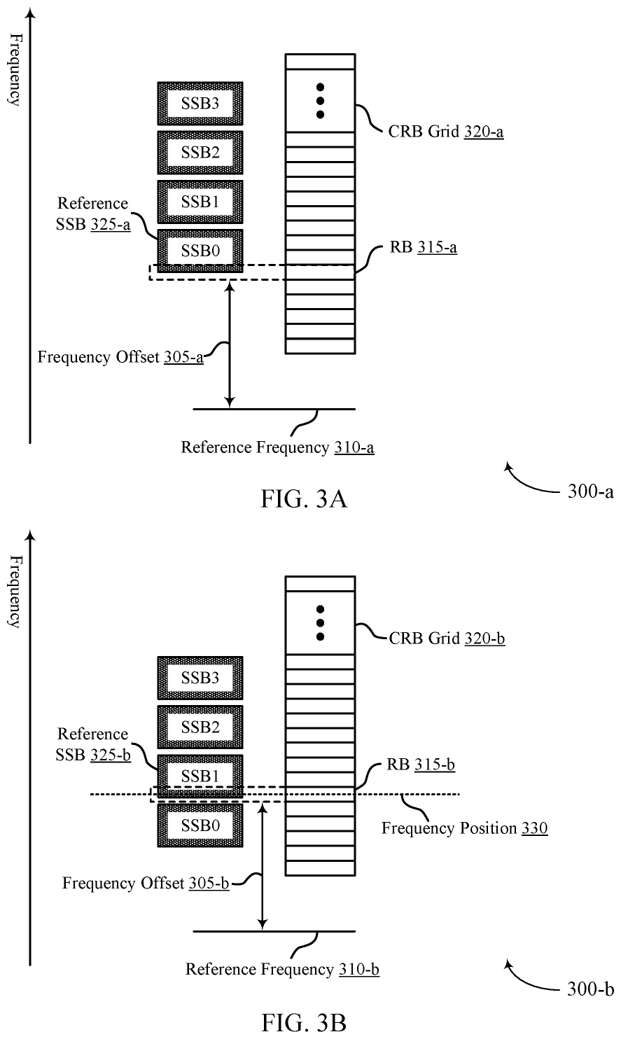

FIGS. 3A and 3B each illustrate an example of a CRB grid diagram 300 that supports techniques for determining a CRB grid with frequency multiplexed SSBs in accordance with one or more aspects of the present disclosure. The CRB grid diagrams 300 (e.g., a CRB grid diagram 300-a and a CRB grid diagram 300-b) may implement aspects of the wireless communications system 100 and the wireless communications system 200. For example, the CRB grid diagrams 300 may be implemented at a UE and a network entity, which may be examples of the corresponding devices illustrated by and described with reference to FIGS. 1 and 2.

In some examples, the network entity may transmit a set of SSBs to the UE. The set of SSBs may be an example of an SSB set illustrated by and described with reference to FIG. 2. For example, the set of SSBs may include multiple SSBs multiplexed in frequency and time. Additionally, the network entity may transmit an indication of a frequency offset (e.g., via the OffsetToPointA IE) to the UE. The frequency offset may represent an offset between a reference frequency (e.g., point A) and a lowest subcarrier of a lowest RB (e.g., among RBs included in a CRB grid), which overlaps with a reference SSB (e.g., an SS/PBCH block). The lowest subcarrier may correspond to a subcarrier associated with a lowest frequency allocation among frequency allocations associated with subcarriers included in the lowest RB. The lowest RB may correspond to an RB associated with a lowest frequency allocation among frequency allocations associated with RBs that may be included in the CRB grid and that may be overlapping with the reference SSB. In some examples, the UE may select the reference SSB in accordance with a rule. That is, the UE may be configured with a rule for selecting the reference SSB for determination of the CRB grid in accordance with the indicated frequency offset.

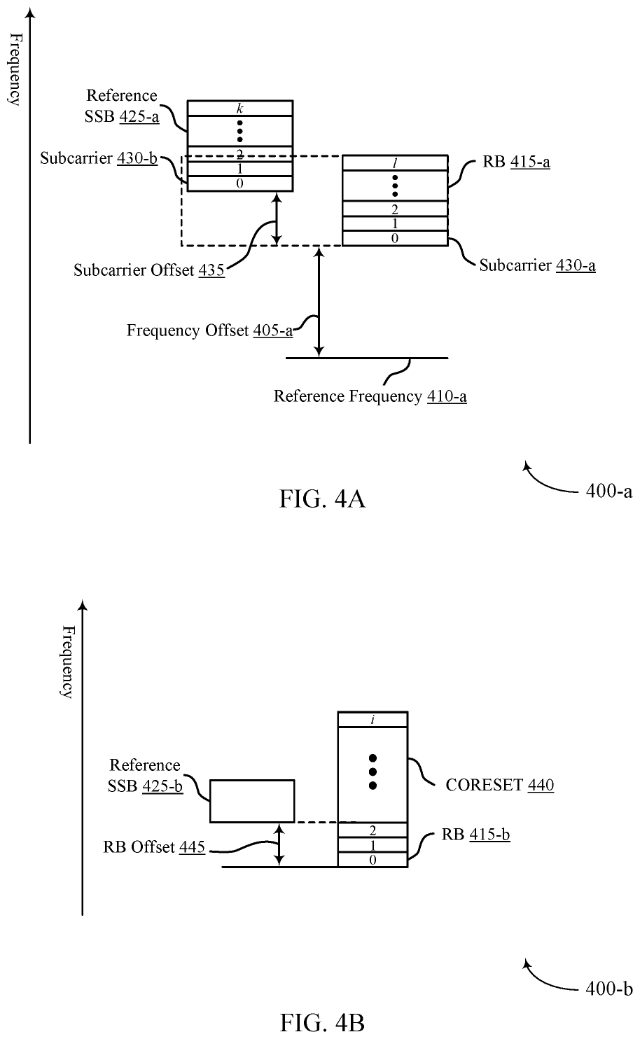

In some examples, the rule may specify (e.g., define, indicate) that selection of the reference SSB may be based on a frequency allocation. As illustrated in the example of FIG. 3A, the rule may specify that selection of a reference SSB 325-a may be based on the reference SSB 325-a being associated with a particular frequency allocation. For example, the rule may specify that selection of a reference SSB 325-a may be based on the reference SSB 325-a being associated with a frequency allocation that corresponds to a lowest frequency allocation among frequency allocations associated with the set of SSBs transmitted to the UE. As illustrated in the example of FIG. 3A, the network entity may simultaneously transmit a subset of SSBs (e.g., included in the set of SSBs) to the UE during a time occasion (e.g., a single time occasion), which may include SSB0, SSB1, SSB2, and SSB3. In such an example, the UE may select SSB0 to use as the reference SSB 325-a based on SSB0 having a lowest frequency allocation among SSB0, SSB1, SSB2, and SSB3. In some examples, SSB0 may include multiple RBs and a lowest RB (e.g., an RB associated with a lowest frequency allocation) among the multiple RBs included in SSB0 may have an index of 0 (e.g., may be RB0). In the example of FIG. 3A, RB0 of SSB0 may have a lowest frequency allocation among RBs included in SSB0, SSB1, SSB2, and SSB3. As such, and in accordance with some examples of the rule, the UE may select SSB0 as the reference SSB 325-a. In such examples, the UE may determine that an RB 315-a corresponds to an RB associated with a lowest frequency allocation among frequency allocations associated with RBs that may be included in a CRB grid 320-a and may overlap with the reference SSB 325-a. Accordingly, the UE may determine that a frequency offset 305-a (e.g., indicated to the UE via the OffsetToPointA IE) may represents an offset (e.g., a difference) between a reference frequency 310-a (e.g., point A) and a subcarrier with a lowest frequency allocation (e.g., a lowest subcarrier) among subcarriers included in the RB 315-a (e.g., the lowest RB among RBs included in a CRB grid 320-a that overlap with the reference SSB 325-a). Although the example of FIG. 4 illustrates the frequency allocation corresponding to the lowest frequency allocation, the frequency allocation may, in some other examples, correspond to a highest frequency allocation. In other words, the rule may configure the UE to select an SSB with a lowest or highest frequency domain allocation (e.g., according to the frequency of RB0 within the SSB) to be a reference SSB for a CRB grid.

In some other examples, the rule may specify (e.g., define, indicate) that selection of the reference SSB may be based on a synchronization raster. That is, the rule may configure the UE to select an SSB that may be transmitted over the synchronization raster as the reference SSB. As illustrated in the example of FIG. 3B, the rule may configure the UE to select a reference SSB 325-b based on the reference SSB 325-b overlapping in frequency with a frequency position 330 (e.g., a reference frequency position). The frequency position 330 may include a frequency position defined by the synchronization raster. In the example of FIG. 3B, the synchronization raster may overlap with an SSB different from an SSB with the lowest (or highest) frequency domain allocation. For example, the frequency position 330, which may be defined based on the synchronization raster, may overlap in frequency with SSB1. Accordingly, the UE may select SSB1 as the reference SSB 325-b. In such examples, the UE may determine that an RB 315-b corresponds to an RB associated with a lowest frequency allocation among frequency allocations associated with RBs included in a

CRB grid 320-b that may be overlapping with the reference SSB 325-b. In such an example, the UE may determine that a frequency offset 305-b (e.g., indicated to the UE via the OffsetToPointA IE) may represent a frequency offset between a reference frequency 310-b (e.g., point A) and a subcarrier with a lowest frequency allocation (e.g., a lowest subcarrier) among subcarriers included in the RB 315-b (e.g., a lowest RB among RBs included in a CRB grid 320-b, which overlaps with the reference SSB 325-b). In some examples, configuring the UE with a rule for selecting a reference SSB from a set of SSBs that may be multiplexed in time and in frequency, may provide improvements to cell selection procedures at the UE, among other possible benefits.

FIGS. 4A and 4B each illustrate an example of an RB diagram 400 that supports techniques for determining a CRB grid with frequency multiplexed SSBs in accordance with one or more aspects of the present disclosure. The RB diagrams 400 (e.g., an RB diagram 400-a and an RB diagram 400-b) may implement aspects of the wireless communications system 100, the wireless communications system 200, and the CRB grid diagrams 300. For example, the RB diagrams 400 may be implemented at a UE and a network entity, which may be examples of the corresponding devices illustrated by and described with reference to FIGS. 1, 2, 3A, and 3B.

In some examples, the network entity may transmit a set of SSBs to the UE. The set of SSBs may be an example of an SSB set illustrated by and described with reference to FIG. 2. For example, the set of SSBs may include multiple SSBs multiplexed in frequency and time. As illustrated in the example of FIG. 4A, the UE may be configured with a subcarrier offset (k_{offset}) to determine a CRB grid (e.g., one or more aspects of a CRB grid) based on a frequency location of one or more of the SSBs included in the set of SSBs. For example, the subcarrier offset may correspond to an offset from a first subcarrier (e.g., subcarrier 0) in a common RB including an SSB to subcarrier 0 of the SSB. In some examples, the subcarrier offset may enable the UE to compensate for a subcarrier mismatch (e.g., a difference) between RBs included in the SSB (e.g., SSB REs) and REs included in the CRB grid (e.g., CRB grid REs).

As illustrated in the example of FIG. 4A, the UE may select a reference SSB 425-a from the set of SSBs. In such an example, the reference SSB 425-a may include multiple subcarriers (e.g., indexed from 0 to k). In some examples, based on selecting the reference SSB 425-a, the UE may determine that an RB 415-a corresponds to an RB associated with a lowest frequency allocation among frequency allocations associated with RBs included in a CRB grid that may be overlapping with the reference SSB 425-a. In other words, the UE may determine that the RB 415-a corresponds to the common RB including the SSB. The RB 415-a may include multiple subcarriers (e.g., indexed from 0 to l).

The network entity may configure the UE (or the UE may be otherwise configured) with a subcarrier offset 435. The UE may determine that the subcarrier offset 435 corresponds to an offset between a subcarrier 430-a of the RB 415-a (e.g., a lowest subcarrier of the RB 415-a, subcarrier 0 of the RB 415-a) and a subcarrier 430-b of the reference SSB 425-a (e.g., a lowest subcarrier of the reference SSB 425-a, subcarrier 0 of the reference SSB 425-a). That is, the subcarrier offset 435 may correspond to an offset from subcarrier 0 in the RB 415-a overlapping with (e.g., including) the reference SSB 425-a to subcarrier 0 of the reference SSB 425-a. In other words, the subcarrier offset 435 may correspond to an offset from a lowest RE in the RB 415-a that is overlapping with the reference SSB 425-a to a lowest RE of the reference SSB 425-a. Accordingly, in some examples, the subcarrier offset 435 may enable the UE to compensate for a subcarrier mismatch between REs included in the reference SSB 425-a and REs included in the CRB grid (e.g., REs included in the RB 415-a, which may be included in the CRB grid).

In some examples, multiple SSBs may be multiplexed in frequency. In such examples, multiple common RBs may be overlapping with a respective subcarrier 0 of each SSB included in the multiple SSBs multiplexed in frequency (e.g., SSBs multiplexed using FDM). For example, the UE may select the reference SSB 425-afrom the set of SSBs transmitted to the UE from the network entity. That is, the reference SSB 425-a may be one of multiple SSBs that may be multiplexed in frequency and in time. Accordingly, multiple RBs included in the CRB grid (e.g., multiple common RBs, including the RB 415-a) may be overlapping with a lowest subcarrier (e.g., subcarrier 0) of multiple SSBs transmitted to the UE. Accordingly, each of the multiple RBs may be associated with a respective (e.g., different) subcarrier offset. For example, a first RB included in the CRB grid may be overlapping with a first SSB (e.g., SSB0) and may be associated with a first subcarrier offset. In such an example, the first subcarrier offset may correspond to an offset between subcarrier 0 in the first RB to subcarrier 0 of the first SSB. Additionally, a second RB included in the CRB grid may be overlapping with a second SSB (e.g., SSB 2) and may be associated with a second subcarrier offset. The second subcarrier offset may correspond to an offset between subcarrier 0 in the second RB to subcarrier 0 of the second SSB. As such, the second subcarrier offset may be different from the first subcarrier offset. In other words, a subcarrier offset from subcarrier 0 in a common RB including SSB0 to subcarrier 0 of the SSB0 may be different from another subcarrier offset from subcarrier 0 in a common RB including SSB 2 to subcarrier 0 of SSB 2. In some examples, if SSBs are multiplexed in frequency, the UE may determine an SSB (e.g., which SSB) to use for determining the subcarrier offset 435. That is, the UE may be configured to with a rule for selecting an SSB (e.g., the first SSB or the second SSB) to use as the reference SSB 425-a for the subcarrier offset 435.

For example, the network entity may configure the UE (or the UE may be otherwise configure) with a rule for selecting an SSB to use as the reference SSB 425-a for determining the subcarrier offset 435 (e.g., if the set of multiple SSBs are multiplexed in frequency). In some examples, the subcarrier offset 435 (k_{offset}) may correspond to a subcarrier offset from subcarrier 0 in the common RB including SSB to subcarrier 0 of the SSB used for determination of the lowest RB of the CRB grid. In other words, the rule may specify (e.g., define, indicate) that the UE may select a same SSB for the subcarrier offset 435 and a frequency offset 405-a. For example, the rule may specify that the subcarrier offset 435 corresponds to an offset from subcarrier 0 in an RB overlapping with an SSB used to determine a lowest RB of the CRB grid to subcarrier 0 of the SSB used to determine the lowest RB of the CRB grid. That is, the subcarrier offset 435 may be from the subcarrier 430-a (e.g., subcarrier 0 in the RB 415-a) to the subcarrier 430-b (e.g., subcarrier 0 of the reference SSB 425-a), in which the reference SSB 425-a may correspond to an SSB used for the determination of the lowest RB of the CRB grid. In other words, the rule may specify that a reference SSB used to identify a reference frequency 410-a (e.g., the reference frequency for the CRB grid) in accordance with the frequency offset 405-a (e.g., indicated to the UE via the OffsetToPointA IE) may be a same reference SSB used to identify the subcarrier 430-a in accordance with the subcarrier offset 435.

In some other examples, the rule may configure the UE to select the reference SSB 425-a based on the reference SSB 425-a being associated with a frequency allocation, such as a highest frequency allocation or a lowest frequency allocation among the set of SSBs. In some examples, the rule may configure the UE to select the reference SSB 425-a based on the reference SSB 425-a overlapping in frequency with a particular frequency position. For example, the rule may configure the UE to select the reference SSB 425-a based on the reference SSB 425-a overlapping in frequency with a frequency position that may be based on a synchronization raster. In some examples, the rule may configure the UE to select an SSB indicated to the UE (e.g., via a MIB) as the reference SSB 425-a.

As illustrated in the example of FIG. 4B, the UE may be configured with an RB offset 445 that the UE may use to identify a frequency position of a CORESET 440 of the CRB grid (e.g., a CORESET for Type0-PDCCH CSS set). The CORESET 440 may include multiple RBs (e.g., indexed from 0 to i). In some examples, the UE may assume that the RB offset 445 corresponds to an offset from a smallest RB index of the CORESET 440 to a smallest RB index of a common RB overlapping with a first RB (e.g., RB0) of a corresponding SSB. In other words, the RB offset 445 may correspond to an offset from an RB 415-b (e.g., a smallest RB index among RBs included in a CORESET 440) to a smallest RB index among RBs included a reference SSB 425-b.

In some examples, the network entity may configure the UE (or the UE may be otherwise configure) with a rule for selecting an SSB to use as the reference SSB 425-b for determining the RB offset 445. For example, in accordance with the rule, the UE may assume that the RB offset 445 corresponds to an offset from the smallest RB index of the CORESET 440 (e.g., for the Type0-PDCCH CSS set) to the smallest RB index of the common RB overlapping with the first RB of the corresponding SSB (e.g., a corresponding SS/PBCH block) used for determination of the lowest RB of the CRB grid (e.g., for the frequency offset 405-a) or the subcarrier offset 435, or both. In other words, the rule may specify that the reference SSB 425-b used to identify the RB 415-b in accordance with the RB offset 445 may be a same reference SSB used to identify the reference frequency 410-a in accordance with the frequency offset 405-a (e.g., indicated to the UE via the OffsetToPointA IE) or a same reference SSB used to identify the subcarrier 430-a in accordance with the subcarrier offset 435, or both.

In some other examples, the rule may configure the UE to select the reference SSB 425-b based on the reference SSB 425-b being associated with a frequency allocation, such as a highest frequency allocation or a lowest frequency allocation among frequency allocations associated with the set of SSBs. In other examples, the rule may configure the UE to select the reference SSB 425-b based on the reference SSB 425-b overlapping in frequency with a frequency position that may be based on a synchronization raster. In some examples, the rule may configure the UE to select an SSB indicated to the UE (e.g., via a MIB) as the reference SSB 425-b. In some examples, configuring the UE with one or more rules for selecting a reference SSB for a frequency offset, a subcarrier offset, or an RB offset, or any combination thereof, may provide improvements to cell selection procedures at the UE, among other possible benefits.

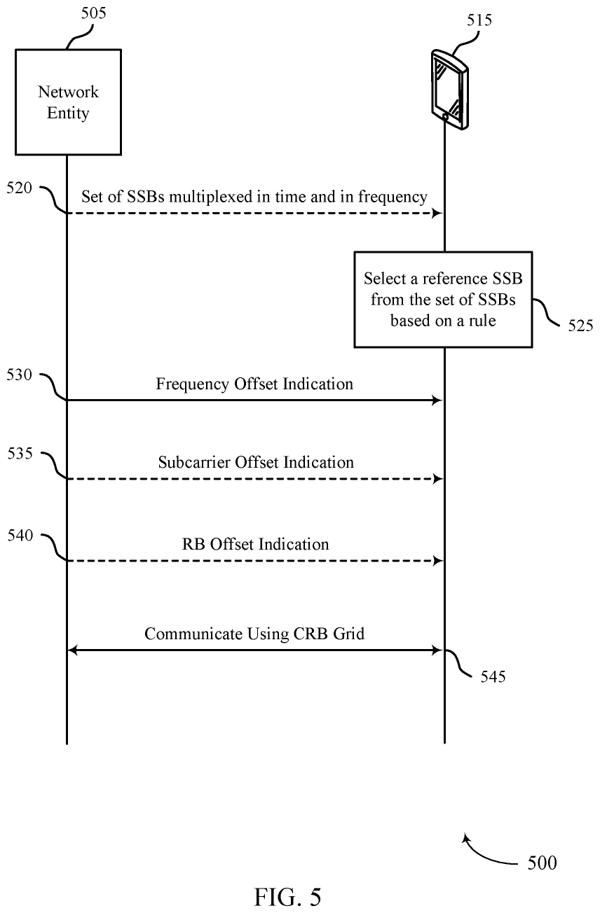

FIG. 5 illustrates an example of a process flow 500 that supports techniques for determining a CRB grid with frequency multiplexed SSBs in accordance with one or more aspects of the present disclosure. The process flow 500 may implement or be implemented at one or more aspects of the wireless communications system 100, the wireless communications system 200, the CRB grid diagrams 300, and the RB diagrams 400. For example, the process flow 500 may be implemented at a UE 515 and a network entity 505, which may be examples of the corresponding devices illustrated by and described with reference to FIGS. 1, 2, 3A, 3B, 4A, ad 4B. The operations performed at the UE 515 and the network entity 505 may support improvements to wireless communications between the UE 515 and the network entity 505, among other benefits. In the following description of the process flow 500, the operations performed at the UE 515 and the network entity 505 may occur in a different order than the example order shown. Additionally, the operations performed at the UE 515 and the network entity 505 may be performed at different times. Some operations may be combined and some operations may be omitted. In some examples, the UE 515 and the network entity 505 may support a framework for selecting a reference SSB from a set of SSBs that may be multiplexed in time and in frequency.

In some examples, at 520, the network entity 505 may transmit a set of SSBs to the UE 515. The set of SSBs may be an example of an SSB set illustrated by and described with reference to FIG. 2. For example, the set of SSBs may be multiplexed in time and in frequency. In some examples, the network entity 505 may use hybrid beamforming to transmit the set of SSBs to the UE 515.

At 525, the UE 515 may select a reference SSB from the set of SSBs. For example, the UE 515 may receive at least one SSB from the set of SSBs. In such an example, the UE 515 may use the received SSB to identify a respective frequency position of one or more other SSBs (e.g., all SSBs) included in the set of SSBs transmitted to the UE 515. In some examples, such as based on identifying the respective frequency position of one or more of the SSBs included in the set of SSBs, the UE 515 may select the reference SSB from the set of SSBs. That is, the UE 515 may select an SSB from the set of SSBs to use as the reference SSB. In some examples, the UE 515 may select the reference SSB based on a rule.

In some examples, the rule may configure the UE 515 to select the reference SSB based on a frequency allocation associated with the reference SSB. For example, the rule may indicate that selection of the reference SSB may be based on the reference SSB being associated with a highest frequency allocation or a lowest frequency allocation among frequency allocations associated with the set of SSBs. In some other examples, the rule may configure the UE 515 to select the reference SSB based on the reference SSB overlapping in frequency with a reference frequency position. For example, the rule may indicate that selection of the SSB is based on the reference SSB overlapping in frequency with a reference frequency position that may be defined by a synchronization raster. In some examples, the rule may configure the UE 515 to select the reference SSB based on an indication (e.g., included in a MIB) of the reference SSB transmitted to the UE 515 from the network entity 505.

At 530, the UE 515 may receive a control message from the network entity 505 that includes a frequency offset indication. The frequency offset indication may be an example of a frequency offset indication illustrated by and described with reference to FIG. 2. For example, the frequency offset indication may indicate a frequency offset between a reference frequency for a CRB grid and an RB that overlaps in frequency with the selected reference SSB.

In some examples, at 535, the UE 515 may receive a subcarrier offset indication that may indicate a subcarrier offset associated with the CRB grid. In some examples, the subcarrier offset may be an example of a subcarrier offset illustrated by and described with reference to FIG. 4A. For example, the subcarrier offset may correspond to an offset between a first subcarrier included in the RB and a second subcarrier included in the selected reference SSB. In some other examples, the UE 515 may select a second reference SSB in accordance with another rule (e.g., different from the rule). In such examples, the subcarrier offset may correspond to an offset between the first subcarrier included in the RB and a third subcarrier included in the second reference SSB.

In some examples, at 540, the UE 515 may receive an RB offset indication that may indicate an RB offset associated with the CRB grid. In some examples, the RB offset may be an example of an RB offset illustrated by and described with reference to FIG. 4B. For example, the RB offset may correspond to an offset between a first RB of a CORESET included in the CRB grid and the RB that overlaps in frequency with the selected reference SSB. In some other examples, the UE 515 may select a second reference SSB in accordance with another rule (e.g., different from the rule). In such examples, the RB offset may correspond to an offset between the first RB of the CORESET included in the CRB grid and a third RB that overlaps in frequency with the second reference SSB.

At 545, the UE 515 may communicate with the network entity 505 using the CRB grid in accordance with the frequency offset, the subcarrier offset, or the RB offset, or any combination thereof. In some examples, configuring the UE 515 with one or more rules for selecting a reference SSB may enable the network entity 505 to multiplex the set of SSBs in time and in frequency, which may lead to reduced power consumption at the UE 515 and the network entity 505, among other possible benefits.

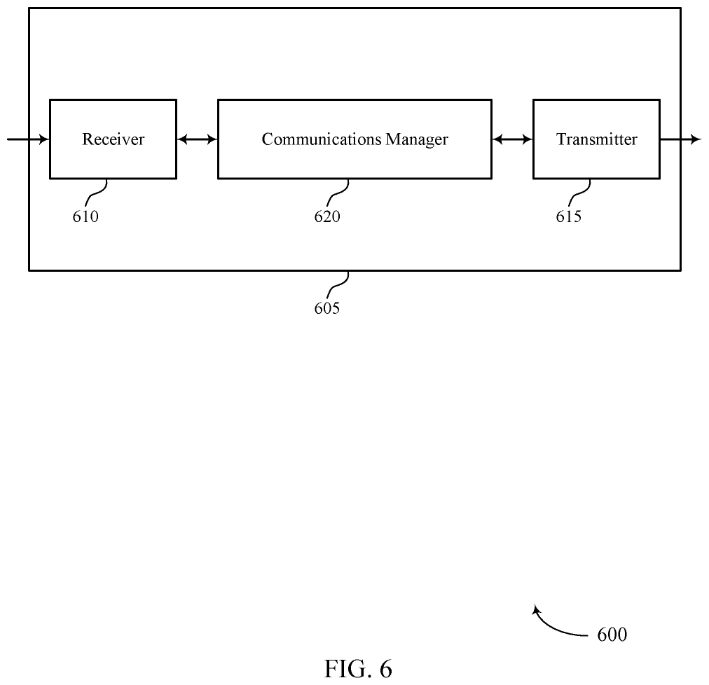

FIG. 6 illustrates a block diagram 600 of a device 605 that supports techniques for determining a CRB grid with frequency multiplexed SSBs in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for determining a CRB grid with frequency multiplexed SSBs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for determining a CRB grid with frequency multiplexed SSBs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for determining a CRB grid with frequency multiplexed SSBs as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE (e.g., the device 605) in accordance with examples as disclosed herein. For example, the communications manager 620 may be configured as or otherwise support a means for selecting a reference SSB from a set of multiple SSBs that are multiplexed in time and frequency, the selection of the reference SSB is based on a rule. The communications manager 620 may be configured as or otherwise support a means for receiving a control message that indicates a frequency offset between a reference frequency for a CRB grid and an RB that overlaps in frequency with the selected reference SSB. The communications manager 620 may be configured as or otherwise support a means for communicating using the CRB grid in accordance with the frequency offset.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced power consumption and more efficient utilization of communication resources.

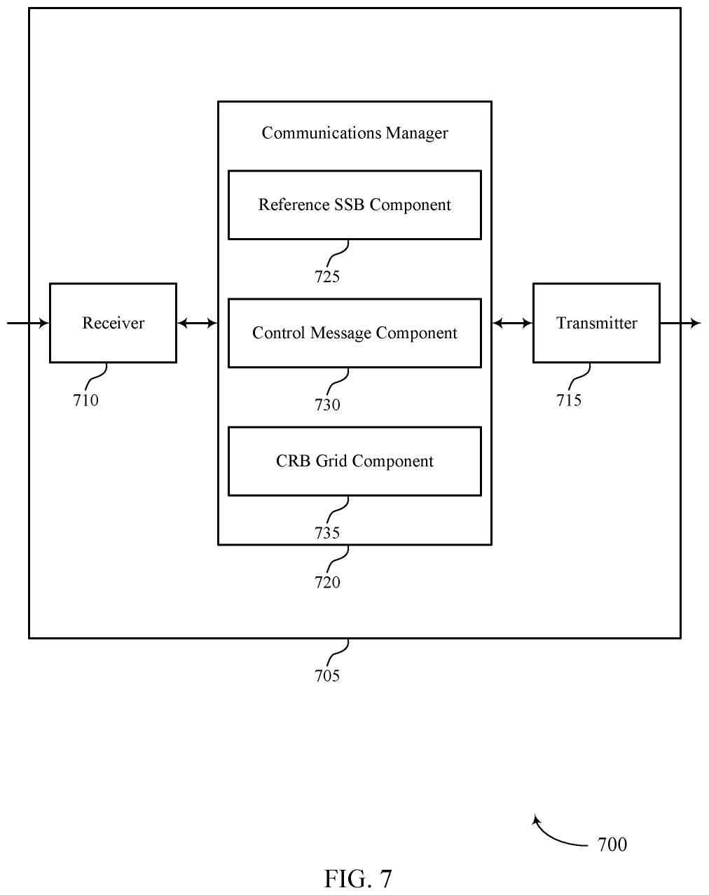

FIG. 7 illustrates a block diagram 700 of a device 705 that supports techniques for determining a CRB grid with frequency multiplexed SSBs in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for determining a CRB grid with frequency multiplexed SSBs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for determining a CRB grid with frequency multiplexed SSBs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for determining a CRB grid with frequency multiplexed SSBs as described herein. For example, the communications manager 720 may include a reference SSB component 725, a control message component 730, an CRB grid component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE (e.g., the device 705) in accordance with examples as disclosed herein. The reference SSB component 725 may be configured as or otherwise support a means for selecting a reference SSB from a set of multiple SSBs that are multiplexed in time and frequency, the selection of the reference SSB is based on a rule. The control message component 730 may be configured as or otherwise support a means for receiving a control message that indicates a frequency offset between a reference frequency for a CRB grid and an RB that overlaps in frequency with the selected reference SSB. The CRB grid component 735 may be configured as or otherwise support a means for communicating using the CRB grid in accordance with the frequency offset.

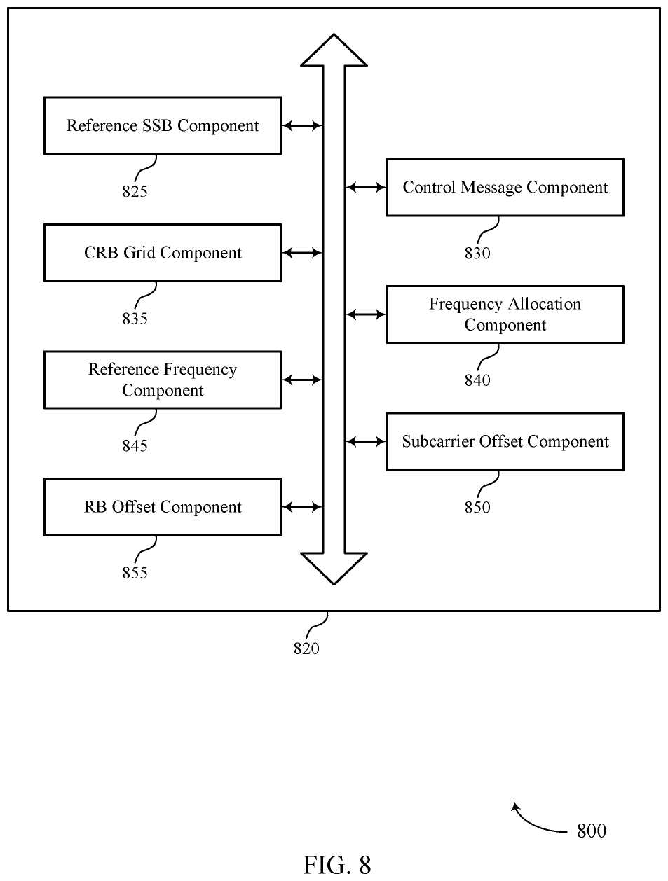

FIG. 8 illustrates a block diagram 800 of a communications manager 820 that supports techniques for determining a CRB grid with frequency multiplexed SSBs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for determining a CRB grid with frequency multiplexed SSBs as described herein. For example, the communications manager 820 may include a reference SSB component 825, a control message component 830, an CRB grid component 835, a frequency allocation component 840, a reference frequency component 845, a subcarrier offset component 850, an RB offset component 855, or any combination thereof. Each of these components may communicate, directly or indirectly, with one another (e.g., via one or more buses).

The communications manager 820 may support wireless communication at a UE in accordance with examples as disclosed herein. The reference SSB component 825 may be configured as or otherwise support a means for selecting a reference SSB from a set of multiple SSBs that are multiplexed in time and frequency, the selection of the reference SSB is based on a rule. The control message component 830 may be configured as or otherwise support a means for receiving a control message that indicates a frequency offset between a reference frequency for a CRB grid and an RB that overlaps in frequency with the selected reference SSB. The CRB grid component 835 may be configured as or otherwise support a means for communicating using the CRB grid in accordance with the frequency offset.

In some examples, to support selecting the reference SSB, the frequency allocation component 840 may be configured as or otherwise support a means for selecting the reference SSB based on a frequency allocation associated with the reference SSB, where the rule indicates that the selection of the reference SSB is based on the reference SSB being associated with the frequency allocation. In some examples, the frequency allocation includes a highest frequency allocation or a lowest frequency allocation among a set of multiple frequency allocations associated with the set of multiple SSBs.

In some examples, to support selecting the reference SSB, the reference frequency component 845 may be configured as or otherwise support a means for selecting the reference SSB based on the reference SSB overlapping in frequency with a reference frequency position, where the rule indicates that the selection of the reference SSB is based on the reference SSB overlapping in frequency with the reference frequency position. In some examples, the reference frequency position includes a frequency position defined by a synchronization raster.

In some examples, the reference SSB component 825 may be configured as or otherwise support a means for receiving an indication of the reference SSB, where the rule indicates that the selection of the reference SSB is based on the indication. In some examples, to support receiving the indication, the reference SSB component 825 may be configured as or otherwise support a means for receiving a MIB that includes a bit that indicates the reference SSB.

In some examples, the subcarrier offset component 850 may be configured as or otherwise support a means for receiving an indication of a subcarrier offset between a first subcarrier included in the RB and a second subcarrier included in the selected reference SSB, where communicating using the CRB grid is in accordance with the frequency offset and the subcarrier offset.

In some examples, the reference SSB component 825 may be configured as or otherwise support a means for selecting a second reference SSB from the set of multiple SSBs that are multiplexed in time and frequency, the selection of the second reference SSB is based on a second rule that is different from the rule. In some examples, the subcarrier offset component 850 may be configured as or otherwise support a means for receiving an indication of a subcarrier offset between a first subcarrier included in a second RB that overlaps in frequency with the selected second reference SSB and a second subcarrier included in the selected second reference SSB, where communicating using the CRB grid is in accordance with the frequency offset and the subcarrier offset.

In some examples, the RB offset component 855 may be configured as or otherwise support a means for receiving an indication of an RB offset between a first RB of a control resource set included in the CRB grid and the RB, where communicating using the CRB grid is in accordance with the frequency offset and the RB offset.

In some examples, the reference SSB component 825 may be configured as or otherwise support a means for selecting a second reference SSB from the set of multiple SSBs that are multiplexed in time and frequency, the selection of the second reference SSB is based on a second rule that is different from the rule. In some examples, the RB offset component 855 may be configured as or otherwise support a means for receiving an indication of an RB offset between a first RB of a control resource set included in the CRB grid and a second RB that overlaps in frequency with the selected second reference SSB, where communicating using the CRB grid is in accordance with the frequency offset and the RB offset.

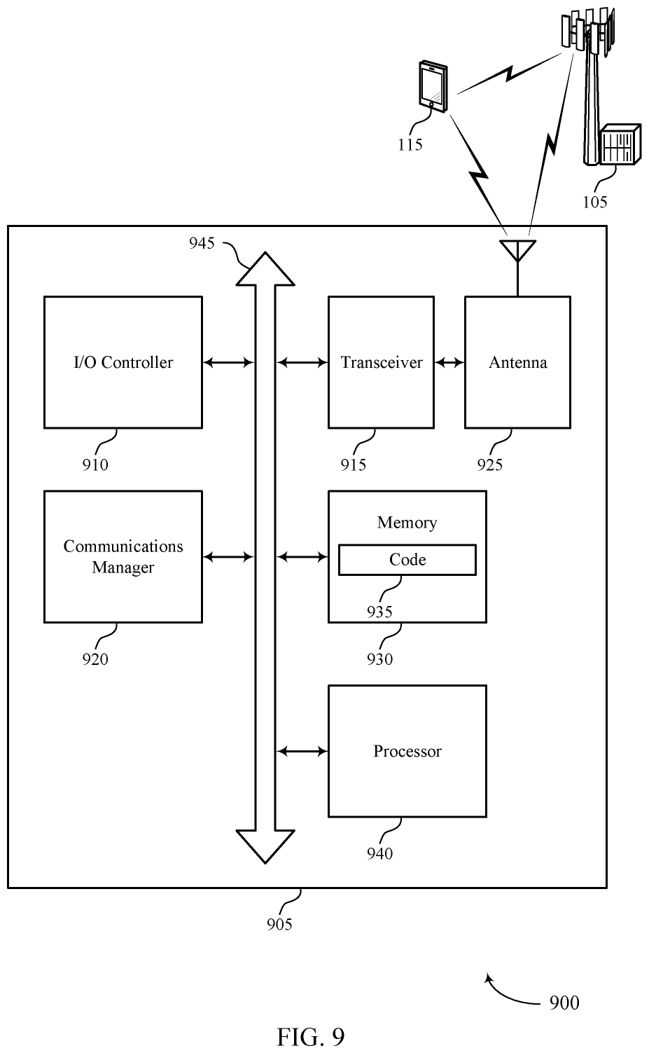

FIG. 9 illustrates a diagram of a system 900 including a device 905 that supports techniques for determining a CRB grid with frequency multiplexed SSBs in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for determining a CRB grid with frequency multiplexed SSBs). For example, the device 905 or a component of the device 905 may include a processor 940 and memory 930 coupled with or to the processor 940, the processor 940 and memory 930 configured to perform various functions described herein.

The communications manager 920 may support wireless communication at a UE (e.g., the device 905) in accordance with examples as disclosed herein. For example, the communications manager 920 may be configured as or otherwise support a means for selecting a reference SSB from a set of multiple SSBs that are multiplexed in time and frequency, the selection of the reference SSB is based on a rule. The communications manager 920 may be configured as or otherwise support a means for receiving a control message that indicates a frequency offset between a reference frequency for a CRB grid and an RB that overlaps in frequency with the selected reference SSB. The communications manager 920 may be configured as or otherwise support a means for communicating using the CRB grid in accordance with the frequency offset.

By including or configuring the communications manager 920 in accordance with examples as described herein, the device 905 may support techniques for reduced power consumption, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for determining a CRB grid with frequency multiplexed SSBs as described herein, or the processor 940 and the memory 930 may be otherwise configured to perform or support such operations.

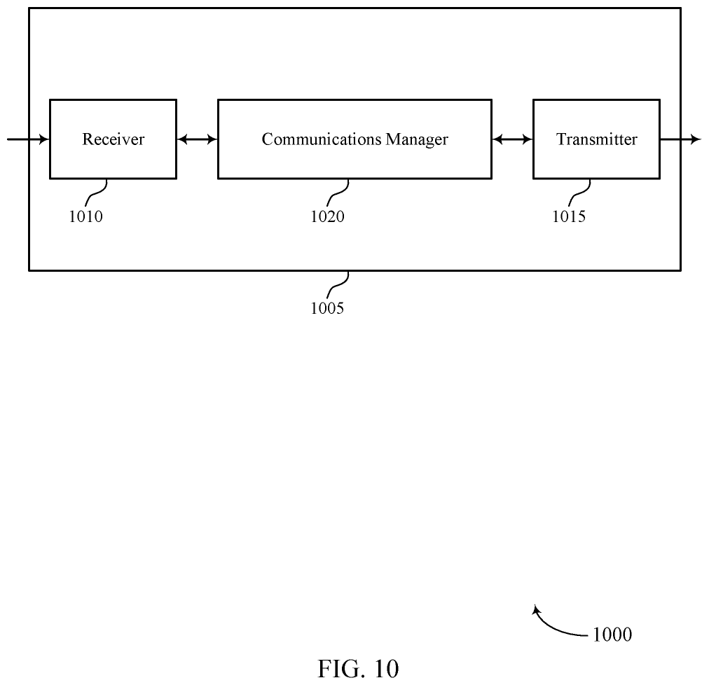

FIG. 10 illustrates a block diagram 1000 of a device 1005 that supports techniques for determining a CRB grid with frequency multiplexed SSBs in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for determining a CRB grid with frequency multiplexed SSBs as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity (e.g., the device 1005) in accordance with examples as disclosed herein. For example, the communications manager 1020 may be configured as or otherwise support a means for outputting a control message that indicates a frequency offset between a reference frequency for a CRB grid and an RB that overlaps in frequency with a reference SSB of a set of multiple SSBs that are multiplexed in time and frequency, where the reference SSB is based on a rule. The communications manager 1020 may be configured as or otherwise support a means for communicating using the CRB grid in accordance with the frequency offset.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced power consumption and more efficient utilization of communication resources.

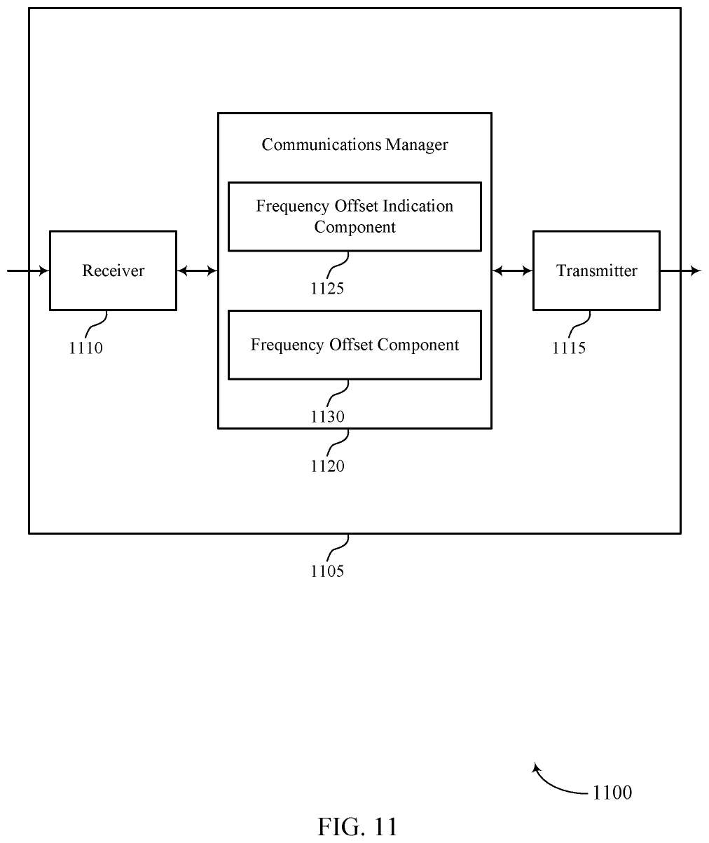

FIG. 11 illustrates a block diagram 1100 of a device 1105 that supports techniques for determining a CRB grid with frequency multiplexed SSBs in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for determining a CRB grid with frequency multiplexed SSBs as described herein. For example, the communications manager 1120 may include a frequency offset indication component 1125 a frequency offset component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The frequency offset indication component 1125 may be configured as or otherwise support a means for outputting a control message that indicates a frequency offset between a reference frequency for a CRB grid and an RB that overlaps in frequency with a reference SSB of a set of multiple SSBs that are multiplexed in time and frequency, where the reference SSB is based on a rule. The frequency offset component 1130 may be configured as or otherwise support a means for communicating using the CRB grid in accordance with the frequency offset.

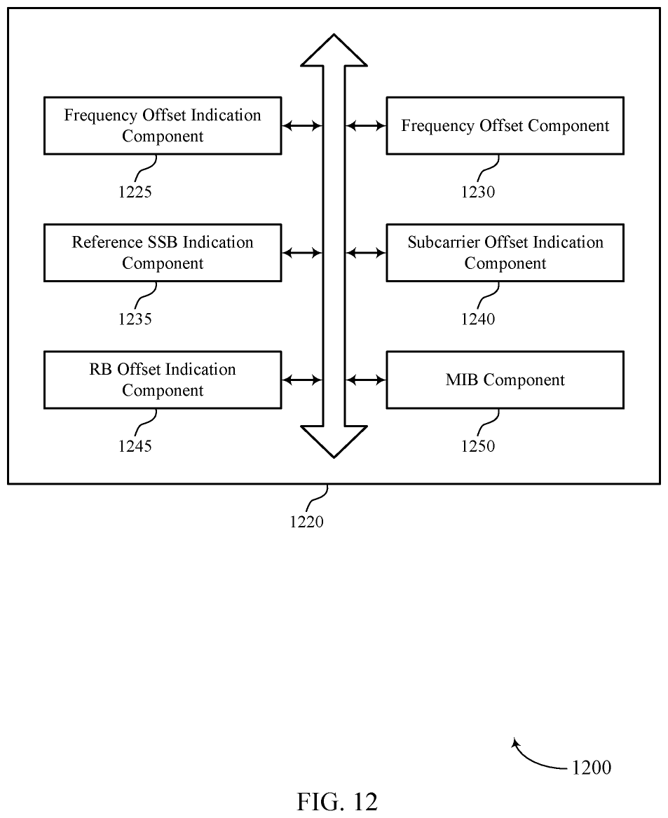

FIG. 12 illustrates a block diagram 1200 of a communications manager 1220 that supports techniques for determining a CRB grid with frequency multiplexed SSBs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for determining a CRB grid with frequency multiplexed SSBs as described herein. For example, the communications manager 1220 may include a frequency offset indication component 1225, a frequency offset component 1230, a reference SSB indication component 1235, a subcarrier offset indication component 1240, an RB offset indication component 1245, a MIB component 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The frequency offset indication component 1225 may be configured as or otherwise support a means for outputting a control message that indicates a frequency offset between a reference frequency for a CRB grid and an RB that overlaps in frequency with a reference SSB of a set of multiple SSBs that are multiplexed in time and frequency, where the reference SSB is based on a rule. The frequency offset component 1230 may be configured as or otherwise support a means for communicating using the CRB grid in accordance with the frequency offset.

In some examples, the rule indicates that the reference SSB is associated with a frequency allocation. In some examples, the frequency allocation includes a highest frequency allocation or a lowest frequency allocation among a set of multiple frequency allocations associated with the set of multiple SSBs.

In some examples, the rule indicates that the reference SSB overlaps in frequency with a reference frequency position. In some examples, the reference frequency position includes a frequency position defined by a synchronization raster.

In some examples, the reference SSB indication component 1235 may be configured as or otherwise support a means for outputting an indication of the reference SSB in accordance with the rule. In some examples, to support outputting the indication, the MIB component 1250 may be configured as or otherwise support a means for outputting a MIB that includes a bit that indicates the reference SSB.

In some examples, the subcarrier offset indication component 1240 may be configured as or otherwise support a means for outputting an indication of a subcarrier offset between a first subcarrier included in the RB and a second subcarrier included in the reference SSB, where communicating using the CRB grid is in accordance with the frequency offset and the subcarrier offset.

In some examples, the subcarrier offset indication component 1240 may be configured as or otherwise support a means for outputting an indication of a subcarrier offset between a first subcarrier included in a second RB that overlaps in frequency with a second reference SSB of the set of multiple SSBs and a second subcarrier included in the second reference SSB, where the second reference SSB is based on a second rule that is different from the rule, and where communicating using the CRB grid is in accordance with the frequency offset and the subcarrier offset.

In some examples, the RB offset indication component 1245 may be configured as or otherwise support a means for outputting an indication of an RB offset between a first RB of a control resource set included in the CRB grid and the RB, where communicating using the CRB grid is in accordance with the frequency offset and the RB offset.

In some examples, the RB offset indication component 1245 may be configured as or otherwise support a means for outputting an indication of an RB offset between a first RB of a control resource set included in the CRB grid and a second RB that overlaps in frequency with a second reference SSB of the set of multiple SSBs, where the second reference SSB is based on a second rule that is different from the rule, and where communicating using the CRB grid is in accordance with the frequency offset and the RB offset.

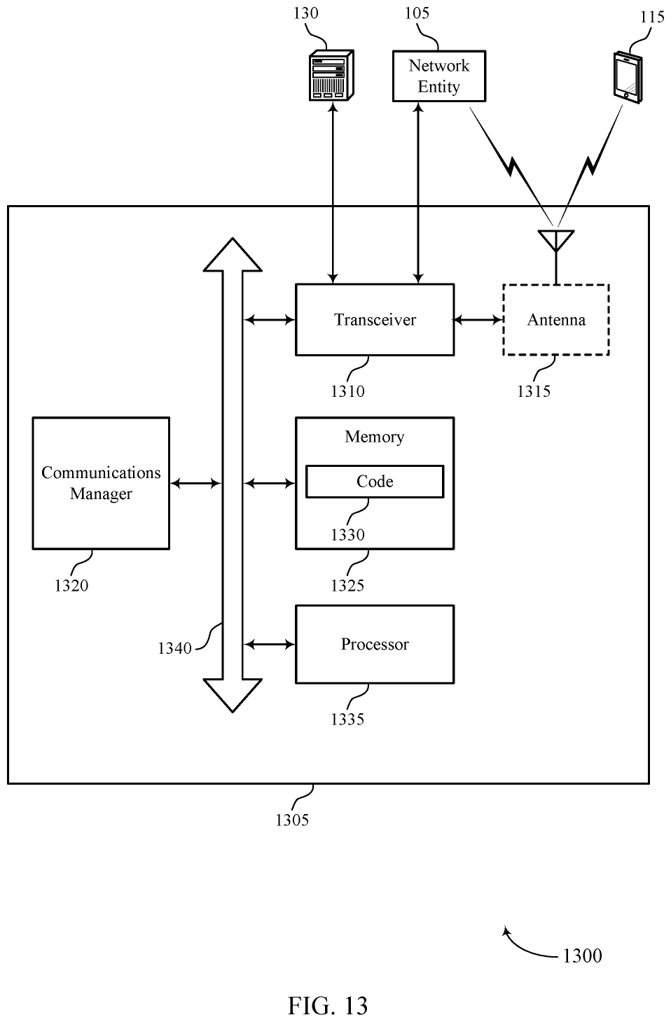

FIG. 13 illustrates a diagram of a system 1300 including a device 1305 that supports techniques for determining a CRB grid with frequency multiplexed SSBs in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for determining a CRB grid with frequency multiplexed SSBs). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity (e.g., the device 1305) in accordance with examples as disclosed herein. For example, the communications manager 1320 may be configured as or otherwise support a means for outputting a control message that indicates a frequency offset between a reference frequency for a CRB grid and an RB that overlaps in frequency with a reference SSB of a set of multiple SSBs that are multiplexed in time and frequency, where the reference SSB is based on a rule. The communications manager 1320 may be configured as or otherwise support a means for communicating using the CRB grid in accordance with the frequency offset.

By including or configuring the communications manager 1320 in

accordance with examples as described herein, the device 1305 may support techniques for reduced power consumption, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of techniques for determining a CRB grid with frequency multiplexed SSBs as described herein, or the processor 1335 and the memory 1325 may be otherwise configured to perform or support such operations.

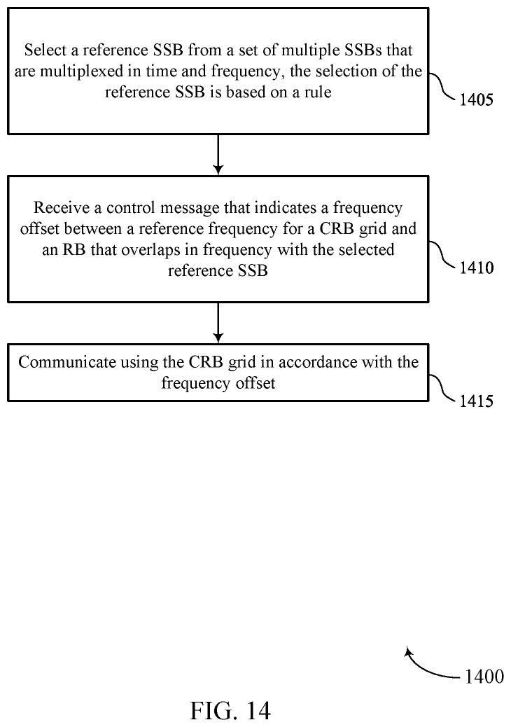

FIG. 14 illustrates a flowchart showing a method 1400 that supports techniques for determining a CRB grid with frequency multiplexed SSBs in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include selecting a reference SSB from a set of multiple SSBs that are multiplexed in time and frequency, the selection of the reference SSB is based on a rule. The operations of 1405 may be performed in accordance with examples as disclosed herein. In some examples, aspects of the operations of 1405 may be performed by a reference SSB component 825 as described with reference to FIG. 8.

At 1410, the method may include receiving a control message that indicates a frequency offset between a reference frequency for a CRB grid and an RB that overlaps in frequency with the selected reference SSB. The operations of 1410 may be performed in accordance with examples as disclosed herein. In some examples, aspects of the operations of 1410 may be performed by a control message component 830 as described with reference to FIG. 8.

At 1415, the method may include communicating using the CRB grid in accordance with the frequency offset. The operations of 1415 may be performed in accordance with examples as disclosed herein. In some examples, aspects of the operations of 1415 may be performed by an CRB grid component 835 as described with reference to FIG. 8.

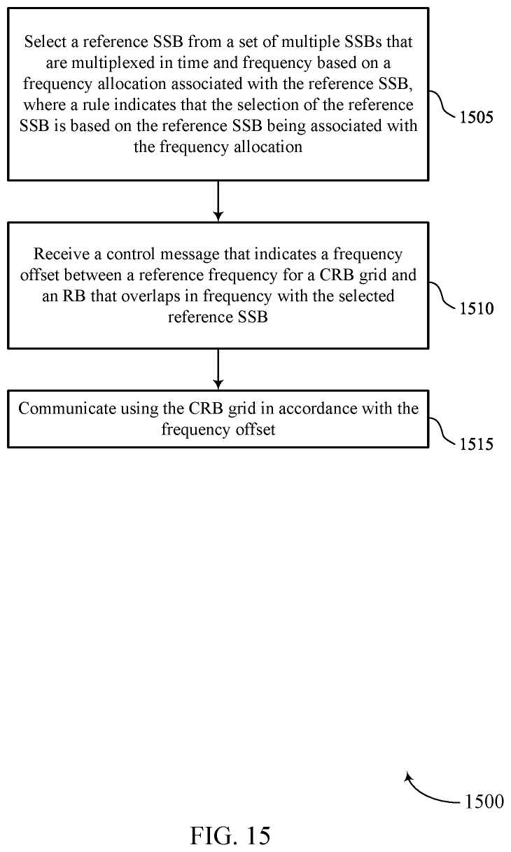

FIG. 15 illustrates a flowchart showing a method 1500 that supports techniques for determining a CRB grid with frequency multiplexed SSBs in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include selecting a reference SSB from a set of multiple SSBs that are multiplexed in time and frequency based on a frequency allocation associated with the reference SSB, where a rule indicates that the selection of the reference SSB is based on the reference SSB being associated with the frequency allocation. The operations of 1505 may be performed in accordance with examples as disclosed herein. In some examples, aspects of the operations of 1505 may be performed by a frequency allocation component 840 as described with reference to FIG. 8.

At 1510, the method may include receiving a control message that indicates a frequency offset between a reference frequency for a CRB grid and an RB that overlaps in frequency with the selected reference SSB. The operations of 1510 may be performed in accordance with examples as disclosed herein. In some examples, aspects of the operations of 1510 may be performed by a control message component 830 as described with reference to FIG. 8.

At 1515, the method may include communicating using the CRB grid in accordance with the frequency offset. The operations of 1515 may be performed in accordance with examples as disclosed herein. In some examples, aspects of the operations of 1515 may be performed by an CRB grid component 835 as described with reference to FIG. 8.

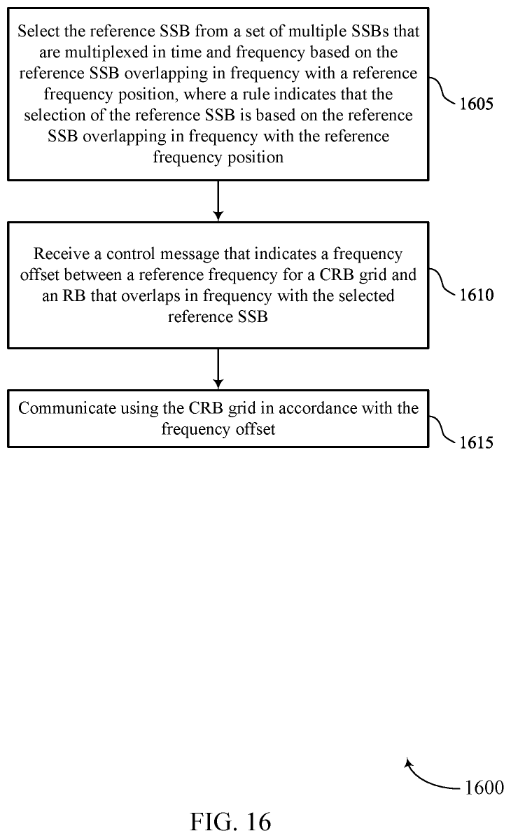

FIG. 16 illustrates a flowchart showing a method 1600 that supports techniques for determining a CRB grid with frequency multiplexed SSBs in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include selecting a reference SSB from a set of multiple SSBs that are multiplexed in time and frequency based on the reference SSB overlapping in frequency with a reference frequency position, where a rule indicates that the selection of the reference SSB is based on the reference SSB overlapping in frequency with the reference frequency position. The operations of 1605 may be performed in accordance with examples as disclosed herein. In some examples, aspects of the operations of 1605 may be performed by a reference frequency component 845 as described with reference to FIG. 8.

At 1610, the method may include receiving a control message that indicates a frequency offset between a reference frequency for a CRB grid and an RB that overlaps in frequency with the selected reference SSB. The operations of 1610 may be performed in accordance with examples as disclosed herein. In some examples, aspects of the operations of 1610 may be performed by a control message component 830 as described with reference to FIG. 8.

At 1615, the method may include communicating using the CRB grid in accordance with the frequency offset. The operations of 1615 may be performed in accordance with examples as disclosed herein. In some examples, aspects of the operations of 1615 may be performed by an CRB grid component 835 as described with reference to FIG. 8.

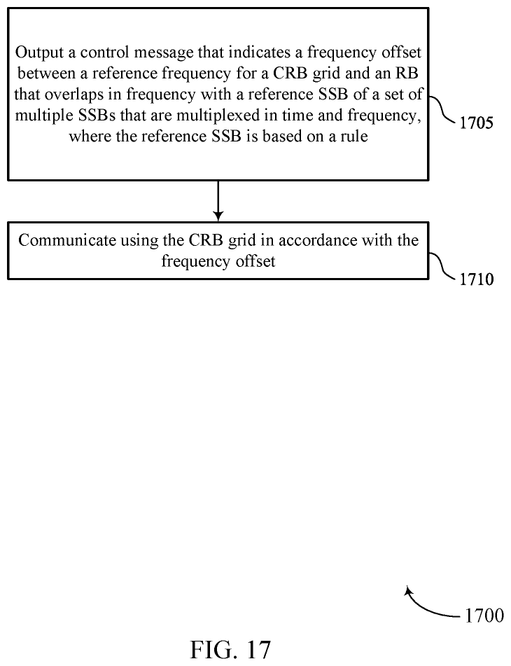

FIG. 17 illustrates a flowchart showing a method 1700 that supports techniques for determining a CRB grid with frequency multiplexed SSBs in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting a control message that indicates a frequency offset between a reference frequency for a CRB grid and an RB that overlaps in frequency with a reference SSB of a set of multiple SSBs that are multiplexed in time and frequency, where the reference SSB is based on a rule. The operations of 1705 may be performed in accordance with examples as disclosed herein. In some examples, aspects of the operations of 1705 may be performed by a frequency offset indication component 1225 as described with reference to FIG. 12.

At 1710, the method may include communicating using the CRB grid in accordance with the frequency offset. The operations of 1710 may be performed in accordance with examples as disclosed herein. In some examples, aspects of the operations of 1710 may be performed by a frequency offset component 1230 as described with reference to FIG. 12.

The following provides an overview of aspects of the present disclosure:

Aspect 1: A method for wireless communication at a UE, comprising: selecting a reference SSB from a plurality of SSBs that are multiplexed in time and frequency, the selection of the reference SSB is based at least in part on a rule; receiving a control message that indicates a frequency offset between a reference frequency for a CRB grid and a RB that overlaps in frequency with the selected reference SSB; and communicating using the CRB grid in accordance with the frequency offset.

Aspect 2: The method of aspect 1, wherein selecting the reference SSB comprises: selecting the reference SSB based at least in part on a frequency allocation associated with the reference SSB, wherein the rule indicates that the selection of the reference SSB is based at least in part on the reference SSB being associated with the frequency allocation.

Aspect 3: The method of aspect 2, wherein the frequency allocation comprises a highest frequency allocation or a lowest frequency allocation among a plurality of frequency allocations associated with the plurality of SSBs.

Aspect 4: The method of aspect 1, wherein selecting the reference SSB comprises: selecting the reference SSB based at least in part on the reference SSB overlapping in frequency with a reference frequency position, wherein the rule indicates that the selection of the reference SSB is based at least in part on the reference SSB overlapping in frequency with the reference frequency position.

Aspect 5: The method of aspect 4, wherein the reference frequency position comprises a frequency position defined by a synchronization raster.

Aspect 6: The method of aspect 1, further comprising: receiving an indication of the reference SSB, wherein the rule indicates that the selection of the reference SSB is based at least in part on the indication.

Aspect 7: The method of aspect 6, wherein receiving the indication comprises: receiving a MIB that comprises a bit that indicates the reference SSB.

Aspect 8: The method of any of aspects 1 through 7, further comprising: receiving an indication of a subcarrier offset between a first subcarrier included in the RB and a second subcarrier included in the selected reference SSB, wherein communicating using the CRB grid is in accordance with the frequency offset and the subcarrier offset.

Aspect 9: The method of any of aspects 1 through 8, further comprising: selecting a second reference SSB from the plurality of SSBs that are multiplexed in time and frequency, the selection of the second reference SSB is based at least in part on a second rule that is different from the rule; and receiving an indication of a subcarrier offset between a first subcarrier included in a second RB that overlaps in frequency with the selected second reference SSB and a second subcarrier included in the selected second reference SSB, wherein communicating using the CRB grid is in accordance with the frequency offset and the subcarrier offset.

Aspect 10: The method of any of aspects 1 through 9, further comprising: receiving an indication of a RB offset between a first RB of a control resource set included in the CRB grid and the RB, wherein communicating using the CRB grid is in accordance with the frequency offset and the RB offset.

Aspect 11: The method of any of aspects 1 through 10, further comprising: selecting a second reference SSB from the plurality of SSBs that are multiplexed in time and frequency, the selection of the second reference SSB is based at least in part on a second rule that is different from the rule; and receiving an indication of a RB offset between a first RB of a control resource set included in the CRB grid and a second RB that overlaps in frequency with the selected second reference SSB, wherein communicating using the CRB grid is in accordance with the frequency offset and the RB offset.

Aspect 12: A method for wireless communication at a network entity, comprising: outputting a control message that indicates a frequency offset between a reference frequency for a CRB grid and a RB that overlaps in frequency with a reference SSB of a plurality of SSBs that are multiplexed in time and frequency, wherein the reference SSB is based at least in part on a rule; and communicating using the CRB grid in accordance with the frequency offset.

Aspect 13: The method of aspect 12, wherein the rule indicates that the reference SSB is associated with a frequency allocation.

Aspect 14: The method of aspect 13, wherein the frequency allocation comprises a highest frequency allocation or a lowest frequency allocation among a plurality of frequency allocations associated with the plurality of SSBs.

Aspect 15: The method of aspect 12, wherein the rule indicates that the reference SSB overlaps in frequency with a reference frequency position.

Aspect 16: The method of aspect 15, wherein the reference frequency position comprises a frequency position defined by a synchronization raster.

Aspect 17: The method of aspect 12, further comprising: outputting an indication of the reference SSB in accordance with the rule.

Aspect 18: The method of aspect 17, wherein outputting the indication comprises: outputting a MIB that comprises a bit that indicates the reference SSB.

Aspect 19: The method of any of aspects 12 through 18, further comprising: outputting an indication of a subcarrier offset between a first subcarrier included in the RB and a second subcarrier included in the reference SSB, wherein communicating using the CRB grid is in accordance with the frequency offset and the subcarrier offset.

Aspect 20: The method of any of aspects 12 through 19, further comprising: outputting an indication of a subcarrier offset between a first subcarrier included in a second RB that overlaps in frequency with a second reference SSB of the plurality of SSBs and a second subcarrier included in the second reference SSB, wherein the second reference SSB is based at least in part on a second rule that is different from the rule, and wherein communicating using the CRB grid is in accordance with the frequency offset and the subcarrier offset.

Aspect 21: The method of any of aspects 12 through 20, further comprising: outputting an indication of a RB offset between a first RB of a control resource set included in the CRB grid and the RB, wherein communicating using the CRB grid is in accordance with the frequency offset and the RB offset.

Aspect 22: The method of any of aspects 12 through 21, further comprising: outputting an indication of a RB offset between a first RB of a control resource set included in the CRB grid and a second RB that overlaps in frequency with a second reference SSB of the plurality of SSBs, wherein the second reference SSB is based at least in part on a second rule that is different from the rule, and wherein communicating using the CRB grid is in accordance with the frequency offset and the RB offset.

Aspect 23: An apparatus for wireless communication at a UE, comprising a processor; memory coupled with the processor; and instructions stored in the memory and executable by the processor to cause the apparatus to perform a method of any of aspects 1 through 11.

Aspect 24: An apparatus for wireless communication at a UE, comprising at least one means for performing a method of any of aspects 1 through 11.

Aspect 25: A non-transitory computer-readable medium storing code for wireless communication at a UE, the code comprising instructions executable by a processor to perform a method of any of aspects 1 through 11.

Aspect 26: An apparatus for wireless communication at a network entity, comprising a processor; memory coupled with the processor; and instructions stored in the memory and executable by the processor to cause the apparatus to perform a method of any of aspects 12 through 22.

Aspect 27: An apparatus for wireless communication at a network entity, comprising at least one means for performing a method of any of aspects 12 through 22.

Aspect 28: A non-transitory computer-readable medium storing code for wireless communication at a network entity, the code comprising instructions executable by a processor to perform a method of any of aspects 12 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor; and
memory coupled to the processor, the memory comprising instructions executable by the processor to cause the apparatus to:
select a reference synchronization signal block from a plurality of synchronization signal blocks that are multiplexed in time and frequency, the selection of the reference synchronization signal block is based at least in part on a rule;
receive a control message that indicates a frequency offset between a reference frequency for a common resource block grid and a resource block that overlaps in frequency with the selected reference synchronization signal block; and
communicate using the common resource block grid in accordance with the frequency offset.

2. The apparatus of claim 1, wherein the instructions to select the reference synchronization signal block are executable by the processor to cause the apparatus to:
select the reference synchronization signal block based at least in part on a frequency allocation associated with the reference synchronization signal block, wherein the rule indicates that the selection of the reference synchronization signal block is based at least in part on the reference synchronization signal block being associated with the frequency allocation.

3. The apparatus of claim 2, wherein the frequency allocation comprises a highest frequency allocation or a lowest frequency allocation among a plurality of frequency allocations associated with the plurality of synchronization signal blocks.

4. The apparatus of claim 1, wherein the instructions to select the reference synchronization signal block are executable by the processor to cause the apparatus to:
select the reference synchronization signal block based at least in part on the reference synchronization signal block overlapping in frequency with a reference frequency position, wherein the rule indicates that the selection of the reference synchronization signal block is based at least in part on the reference synchronization signal block overlapping in frequency with the reference frequency position.

5. The apparatus of claim 4, wherein the reference frequency position comprises a frequency position defined by a synchronization raster.

6. The apparatus of claim 1, wherein the instructions are further executable by the processor to cause the apparatus to:
receive an indication of the reference synchronization signal block, wherein the rule indicates that the selection of the reference synchronization signal block is based at least in part on the indication.

7. The apparatus of claim 6, wherein the instructions to receive the indication are executable by the processor to cause the apparatus to:
receive a master information block that comprises a bit that indicates the reference synchronization signal block.

8. The apparatus of claim 1, wherein the instructions are further executable by the processor to cause the apparatus to:
receive an indication of a subcarrier offset between a first subcarrier included in the resource block and a second subcarrier included in the selected reference synchronization signal block, wherein communicating using the common resource block grid is in accordance with the frequency offset and the subcarrier offset.

9. The apparatus of claim 1, wherein the instructions are further executable by the processor to cause the apparatus to:
select a second reference synchronization signal block from the plurality of synchronization signal blocks that are multiplexed in time and frequency, the selection of the second reference synchronization signal block is based at least in part on a second rule that is different from the rule; and
receive an indication of a subcarrier offset between a first subcarrier included in a second resource block that overlaps in frequency with the selected second reference synchronization signal block and a second subcarrier included in the selected second reference synchronization signal block, wherein communicating using the common resource block grid is in accordance with the frequency offset and the subcarrier offset.

10. The apparatus of claim 1, wherein the instructions are further executable by the processor to cause the apparatus to:
receive an indication of a resource block offset between a first resource block of a control resource set included in the common resource block grid and the resource block, wherein communicating using the common resource block grid is in accordance with the frequency offset and the resource block offset.

11. The apparatus of claim 1, wherein the instructions are further executable by the processor to cause the apparatus to:
select a second reference synchronization signal block from the plurality of synchronization signal blocks that are multiplexed in time and frequency, the selection of the second reference synchronization signal block is based at least in part on a second rule that is different from the rule; and
receive an indication of a resource block offset between a first resource block of a control resource set included in the common resource block grid and a second resource block that overlaps in frequency with the selected second reference synchronization signal block, wherein communicating using the common resource block grid is in accordance with the frequency offset and the resource block offset.

12. An apparatus for wireless communication at a network entity, comprising:
a processor; and
memory coupled to the processor, the memory comprising instructions executable by the processor to cause the apparatus to:
output a control message that indicates a frequency offset between a reference frequency for a common resource block grid and a resource block that overlaps in frequency with a reference synchronization signal block of a plurality of synchronization signal blocks that are multiplexed in time and frequency, wherein the reference synchronization signal block is based at least in part on a rule; and
communicate using the common resource block grid in accordance with the frequency offset.

13. The apparatus of claim 12, wherein the rule indicates that the reference synchronization signal block is associated with a frequency allocation.

14. The apparatus of claim 13, wherein the frequency allocation comprises a highest frequency allocation or a lowest frequency allocation among a plurality of frequency allocations associated with the plurality of synchronization signal blocks.

15. The apparatus of claim 12, wherein the rule indicates that the reference synchronization signal block overlaps in frequency with a reference frequency position.

16. The apparatus of claim 15, wherein the reference frequency position comprises a frequency position defined by a synchronization raster.

17. The apparatus of claim 12, wherein the instructions are further executable by the processor to cause the apparatus to:
output an indication of the reference synchronization signal block in accordance with the rule.

18. The apparatus of claim 17, wherein the instructions to output the indication are executable by the processor to cause the apparatus to:
output a master information block that comprises a bit that indicates the reference synchronization signal block.

19. The apparatus of claim 12, wherein the instructions are further executable by the processor to cause the apparatus to:
output an indication of a subcarrier offset between a first subcarrier included in the resource block and a second subcarrier included in the reference synchronization signal block, wherein communicating using the common resource block grid is in accordance with the frequency offset and the subcarrier offset.

20. The apparatus of claim 12, wherein the instructions are further executable by the processor to cause the apparatus to:
output an indication of a subcarrier offset between a first subcarrier included in a second resource block that overlaps in frequency with a second reference synchronization signal block of the plurality of synchronization signal blocks and a second subcarrier included in the second reference synchronization signal block, wherein the second reference synchronization signal block is based at least in part on a second rule that is different from the rule, and wherein communicating using the common resource block grid is in accordance with the frequency offset and the subcarrier offset.

21. The apparatus of claim 12, wherein the instructions are further executable by the processor to cause the apparatus to:
output an indication of a resource block offset between a first resource block of a control resource set included in the common resource block grid and the resource block, wherein communicating using the common resource block grid is in accordance with the frequency offset and the resource block offset.

22. The apparatus of claim 12, wherein the instructions are further executable by the processor to cause the apparatus to:
output an indication of a resource block offset between a first resource block of a control resource set included in the common resource block grid and a second resource block that overlaps in frequency with a second reference synchronization signal block of the plurality of synchronization signal blocks, wherein the second reference synchronization signal block is based at least in part on a second rule that is different from the rule, and wherein communicating using the common resource block grid is in accordance with the frequency offset and the resource block offset.

23. A method for wireless communication at a user equipment (UE), comprising:
selecting a reference synchronization signal block from a plurality of synchronization signal blocks that are multiplexed in time and frequency, the selection of the reference synchronization signal block is based at least in part on a rule;
receiving a control message that indicates a frequency offset between a reference frequency for a common resource block grid and a resource block that overlaps in frequency with the selected reference synchronization signal block; and
communicating using the common resource block grid in accordance with the frequency offset.

24. The method of claim 23, wherein selecting the reference synchronization signal block comprises:
selecting the reference synchronization signal block based at least in part on a frequency allocation associated with the reference synchronization signal block, wherein the rule indicates that the selection of the reference synchronization signal block is based at least in part on the reference synchronization signal block being associated with the frequency allocation.

25. The method of claim 23, wherein selecting the reference synchronization signal block comprises:
selecting the reference synchronization signal block based at least in part on the reference synchronization signal block overlapping in frequency with a reference frequency position, wherein the rule indicates that the selection of the reference synchronization signal block is based at least in part on the reference synchronization signal block overlapping in frequency with the reference frequency position.

26. The method of claim 23, further comprising:
receiving an indication of the reference synchronization signal block, wherein the rule indicates that the selection of the reference synchronization signal block is based at least in part on the indication.

27. The method of claim 23, further comprising:
receiving an indication of a subcarrier offset between a first subcarrier included in the resource block and a second subcarrier included in the selected reference synchronization signal block, wherein communicating using the common resource block grid is in accordance with the frequency offset and the subcarrier offset.

28. A method for wireless communication at a network entity, comprising:
outputting a control message that indicates a frequency offset between a reference frequency for a common resource block grid and a resource block that overlaps in frequency with a reference synchronization signal block of a plurality of synchronization signal blocks that are multiplexed in time and frequency, wherein the reference synchronization signal block is based at least in part on a rule; and
communicating using the common resource block grid in accordance with the frequency offset.

29. The method of claim 28, further comprising:
outputting an indication of the reference synchronization signal block in accordance with the rule.

30. The method of claim 28, further comprising:
outputting an indication of a resource block offset between a first resource block of a control resource set included in the common resource block grid and the resource block, wherein communicating using the common resource block grid is in accordance with the frequency offset and the resource block offset.
